(19) United States
(12) Patent Application Publication
(10) Pub. No.: US 2026/0031955 A1
(43) Pub. Date: Jan. 29, 2026

(54) METHODS AND APPARATUSES FOR DETERMINING DMRS PORT MODE

(71) Applicant: LENOVO (BEIJING) LIMITED, Beijing (CN)

(72) Inventors: Lingling XIAO, Beijing (CN); Bingchao LIU, Beijing (CN); Chenxi ZHU, Fairfax, VA (US); Wei LING, Beijing (CN); Yi ZHANG, Beijing (CN)

(21) Appl. No.: 18/997,995

(22) PCT Filed: Jul. 27, 2022
(86) PCT No.: PCT/CN2022/108378

§ 371 Date: Jan. 23, 2025

(51) Int. Cl. H04L 5/00

(52) U.S. Cl. CPC H04L 5/0053

(57) ABSTRACT

Embodiments of the present disclosure relate to methods and apparatuses for determining demodulation reference signal (DMRS) port mode. According to an embodiment of the present disclosure, a user equipment (UE) can include: a receiver configured to: receive at least one DMRS configuration associated with a first mode of DMRS ports and a second mode of DMRS ports; receive an indication indicating a DMRS port mode of DMRS port(s) for at least one of a physical downlink shared channel (PDSCH) transmission or a physical uplink shared channel (PUSCH) transmission in an active bandwidth part (BWP), wherein the DMRS port mode is the first mode or the second mode; a processor coupled to the receiver; and a transmitter coupled to the processor.

### TECHNICAL FIELD

Embodiments of the present disclosure are related to wireless communication technology, and more particularly, related to methods and apparatuses for determining a demodulation reference signal (DMRS or DM-RS) port mode.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, DMRS ports may be used for transmitting DMRS for physical uplink shared channel (PUSCH) and physical downlink shared channel (PDSCH). With the development of the communication technology, the number of orthogonal DMRS ports may be increased via various methods. Therefore, new designs for determining a DMRS port mode are needed.

### SUMMARY

According to some embodiments of the present disclosure, a user equipment (UE) may include: a receiver configured to: receive at least one DMRS configuration associated with a first mode of DMRS ports and a second mode of DMRS ports; receive an indication indicating a DMRS port mode of DMRS port(s) for at least one of a PDSCH transmission or a PUSCH transmission in an active bandwidth part (BWP), wherein the DMRS port mode is the first mode or the second mode; a processor coupled to the receiver; and a transmitter coupled to the processor.

In some embodiments of the present application, the indication is a DMRS port mode field in a non-fallback downlink control information (DCI) format for scheduling or activating the PDSCH transmission or the PUSCH transmission, and the processor is configured to: determine an antenna port table based on the DMRS port mode and a DMRS configuration of the at least one DMRS configuration for the PDSCH transmission or the PUSCH transmission, wherein the DMRS configuration is associated with the DMRS port mode of DMRS port(s) indicated by the indication; and determine DMRS port(s) for the PDSCH transmission or the PUSCH transmission based on the antenna port table and an antenna port field included in the non-fallback DCI format.

In some embodiments of the present application, the first mode of DMRS ports and the second mode of DMRS ports are associated with different antenna port tables or share the same antenna port tables.

In some embodiments of the present application, a bit width of the antenna port field included in the non-fallback DCI format is a maximum bit width of a bit width required to indicate antenna port(s) for the first mode of DMRS ports and a bit width required to indicate antenna port(s) for the second mode of DMRS port.

In some embodiments of the present application, the indication is a DMRS port mode field in a configured grant (CG) configuration for the PUSCH transmission in the case that the PUSCH transmission is a type 1 CG PUSCH transmission.

In some embodiments of the present application, the indication is an antenna port field in a non-fallback DCI format for scheduling or activating the PDSCH transmission or the PUSCH transmission, and the antenna port field indicates an index of an entry, which indicates the DMRS port(s) and the DMRS port mode, of an antenna port table shared by the first mode of DMRS ports and the second mode of DMRS ports.

In some embodiments of the present application, the antenna port table includes a first set of entries associated with the first mode of DMRS ports and a second set of entries associated with the second mode of DMRS ports, and the processor is further configured to: determine the DMRS port mode of the DMRS port(s) based on the index of the entry indicated by the antenna port field.

In some embodiments of the present application, the processor is further configured to perform at least one of: determining the DMRS port mode of the DMRS port(s) based on the number of DMRS code division multiplexing (CDM) groups without data indicated by the entry; determining the DMRS port mode of the DMRS port(s) based on a length of frequency-domain orthogonal cover code (FD-OCC) indicated by the entry; or determining the DMRS port mode of the DMRS port(s) based on the number of DMRS ports within a CDM group indicated by the entry.

In some embodiments of the present application, the processor is further configured to: in the case that the number of DMRS CDM groups without data is not larger than 2 for DMRS type 1 or not larger than 3 for DMRS type 2, determine that the DMRS port mode of the DMRS port(s) is the first mode; and in the case that the number of DMRS CDM groups without data is larger than 2 for DMRS type 1 or larger than 3 for DMRS type 2, determine that the DMRS port mode of the DMRS port(s) is the second mode.

In some embodiments of the present application, the processor is further configured to: in the case that the length of FD-OCC is 2, determine that the DMRS port mode of the DMRS port(s) is the first mode; and in the case that the number of DMRS CDM group is larger than 2, determine that the DMRS port mode of the DMRS port(s) is the second mode.

In some embodiments of the present application, the processor is further configured to: in the case that the number of DMRS ports within a CDM group is 2 for single-symbol DMRS or 4 for double-symbol DMRS, determine that the DMRS port mode of the DMRS port(s) is the first mode; and in the case that the number of DMRS ports within a CDM group is 4 for single-symbol DMRS or is 8 for double-symbol DMRS, determine that the DMRS port mode of the DMRS port(s) is the second mode.

In some embodiments of the present application, the DMRS port mode is the first mode for the PDSCH transmission or the PUSCH transmission scheduled by a fallback DCI format.

In some embodiments of the present application, the indication is a DMRS port mode field in a non-fallback DCI format scheduling or activating the PDSCH transmission or the PUSCH transmission, and the processor is configured to: apply the DMRS port mode to all the PDSCH transmissions or all the PUSCH transmissions in the active BWP after an application time of the indication.

In some embodiments of the present application, for the non-fallback DCI format scheduling the PDSCH transmission, the application time is a number of time units after the last symbol of a physical uplink control channel (PUCCH) carrying hybrid automatic repeat request (HARQ)-acknowledgement (ACK) information for the PDSCH transmission; or for the non-fallback DCI format scheduling the PUSCH transmission, the application time is a number of time units after the last symbol of another DCI format scheduling another PUSCH transmission with a same HARQ process number and having a toggled new data indicator (NDI) field value.

In some embodiments of the present application, the DMRS port mode field is a 1-bit field, and wherein a first value of the 1-bit field indicates that the DMRS port mode is the first mode and a second value of the 1-bit field indicates that the DMRS port mode is the second mode.

In some embodiments of the present application, the indication is indicated by a group common DCI format scrambled with a radio network temporary identity (RNTI) specific for DMRS port mode indication.

In some embodiments of the present application, the group common DCI format includes one or more indications, wherein each indication of the one or more indications is for a corresponding UE, and the receiver is further configured to receive configuration information indicating the RNTI and configuration information indicating a payload size of the group common DCI format and a start position of the indication for the UE within the group common DCI format.

In some embodiments of the present application, the indication includes a first indication indicating a DMRS port mode for a PDSCH transmission and a second indication indicating a DMRS port mode for a PUSCH transmission, and the processor is further configured to: apply the DMRS port mode for a PDSCH transmission to all the PDSCH transmissions in the active BWP after receiving the first indication; and apply the DMRS port mode for a PUSCH transmission to all the PUSCH transmissions in the active BWP after receiving the second indication.

In some embodiments of the present application, the indication indicates a DMRS port mode for both a PDSCH transmission and a PUSCH transmission, and the processor is further configured to: apply the DMRS port mode to all the PDSCH transmissions and all the PUSCH transmissions in the active BWP after receiving the indication.

In some embodiments of the present application, the RNTI specific for DMRS port mode indication is a downlink-RNTI (DL-RNTI) specific for DMRS port mode indication for a PDSCH transmission, and the processor is further configured to: apply the DMRS port mode indicated by the indication to all the PDSCH transmissions in the active BWP after receiving the indication; or the RNTI specific for DMRS port mode indication is an uplink-RNTI (UL-RNTI) specific for DMRS port mode indication for a PUSCH transmission, and the processor is further configured to: apply the DMRS port mode indicated by the indication to all the PUSCH transmissions in the active BWP after receiving the indication.

In some embodiments of the present application, the indication is a DMRS port mode field in a medium access control (MAC) control element (CE), and the processor is further configured to: apply the DMRS port mode to all the PDSCH transmissions, all the PUSCH transmission, or all the PDSCH transmissions and all the PUSCH transmission in the active BWP after an application time of the MAC CE.

In some embodiments of the present application, the indication is indicated by a radio resource control (RRC) signalling for a PDSCH transmission or for a PUSCH transmission, and the processor is further configured to: apply the DMRS port mode for all the PDSCH transmissions or all the PUSCH transmission in the active BWP after receiving the RRC signalling.

In some embodiments of the present application, all the PDSCH transmissions include at least one of dynamic scheduled PDSCH transmission(s) or semi-persistent scheduling (SPS) PDSCH transmission(s) in the active BWP; or all the PUSCH transmissions include at least one of dynamic scheduled PUSCH transmission(s) or CG PUSCH transmission(s) in the active BWP.

According to some other embodiments of the present application, a base station (BS), comprising: a transmitter configured to: transmit at least one DMRS configuration associated with a first mode of DMRS ports and a second mode of DMRS ports; transmit an indication indicating a DMRS port mode of DMRS port(s) for at least one of a PDSCH or a PUSCH transmission in an active BWP, wherein the DMRS port mode is the first mode or the second mode; a processor coupled to the transmitter; and a receiver coupled to the processor.

In some embodiments of the present application, the indication is a DMRS port mode field in a non-fallback DCI format for scheduling or activating the PDSCH transmission or the PUSCH transmission, and the processor is configured to: determine an antenna port table based on the DMRS port mode and a DMRS configuration of the at least one DMRS configuration for the PDSCH transmission or the PUSCH transmission, wherein the DMRS configuration is associated with the DMRS port mode of DMRS port(s) indicated by the indication; and determine DMRS port(s) for the PDSCH transmission or the PUSCH transmission based on the antenna port table and an antenna port field included in the non-fallback DCI format.

In some embodiments of the present application, the first mode of DMRS ports and the second mode of DMRS ports are associated with different antenna port tables or share the same antenna port tables.

In some embodiments of the present application, a bit width of the antenna port field included in the non-fallback DCI format is a maximum bit width of a bit width required to indicate antenna port(s) for the first mode of DMRS ports and a bit width required to indicate antenna port(s) for the second mode of DMRS port.

In some embodiments of the present application, the indication is a DMRS port mode field in a CG configuration for the PUSCH transmission in the case that the PUSCH transmission is a type 1 CG PUSCH transmission.

In some embodiments of the present application, the indication is an antenna port field in a non-fallback DCI format for scheduling or activating the PDSCH transmission or the PUSCH transmission, and the antenna port field indicates an index of an entry, which indicates the DMRS port(s) and the DMRS port mode, of an antenna port table shared by the first mode of DMRS ports and the second mode of DMRS ports.

In some embodiments of the present application, the antenna port table includes a first set of entries associated with the first mode of DMRS ports and a second set of entries associated with the second mode of DMRS ports, and the processor is further configured to: determine the DMRS port mode based on the index of the entry indicated by the antenna port field.

In some embodiments of the present application, the processor is further configured to perform at least one of: determining the DMRS port mode of the DMRS port(s) based on the number of DMRS CDM groups without data indicated by the entry; determining the DMRS port mode of the DMRS port(s) based on a length of FD-OCC indicated by the entry; or determining the DMRS port mode of the DMRS port(s) based on the number of DMRS ports within a CDM group indicated by the entry.

In some embodiments of the present application, the processor is further configured to: in the case that the number of DMRS CDM groups without data is not larger than 2 for DMRS type 1 or not larger than 3 for DMRS type 2, determine that the DMRS port mode of the DMRS port(s) is the first mode; and in the case that the number of DMRS CDM groups is larger than 2 for DMRS type 1 or larger than 3 for DMRS type 2, determine that the DMRS port mode of the DMRS port(s) is the second mode.

In some embodiments of the present application, the processor is further configured to: in the case that the length of FD-OCC is 2, determine that the DMRS port mode of the DMRS port(s) is the first mode; and in the case that the number of DMRS CDM group is larger than 2, determine that the DMRS port mode of the DMRS port(s) is the second mode.

In some embodiments of the present application, the processor is further configured to: in the case that the number of DMRS ports within a CDM group is 2 for single-symbol DMRS or 4 for double-symbol DMRS, determine that the DMRS port mode of the DMRS port(s) is the first mode; and in the case that the number of DMRS ports within a CDM group is 4 for single-symbol DMRS or is 8 for double-symbol DMRS; determine that the DMRS port mode of the DMRS port(s) is the second mode.

In some embodiments of the present application, the DMRS port mode is the first mode for the PDSCH transmission or the PUSCH transmission scheduled by a fallback DCI format.

In some embodiments of the present application, the indication is a DMRS port mode field in a non-fallback DCI format scheduling or activating the PDSCH transmission or the PUSCH transmission, and the processor is configured to: apply the DMRS port mode to all the PDSCH transmissions or all the PUSCH transmissions in the active BWP after an application time of the indication.

In some embodiments of the present application, for the non-fallback DCI format scheduling or activating the PDSCH transmission, the application time is a number of time units after the last symbol of a physical uplink control channel (PUCCH) carrying HARQ-ACK information for the PDSCH transmission; or for the non-fallback DCI format scheduling the PUSCH transmission, the application time is a number of time units after the last symbol of another DCI format scheduling another PUSCH transmission with a same HARQ process number and having a toggled NDI field value.

In some embodiments of the present application, the DMRS port mode field is a 1-bit field, and wherein a first value of the 1-bit field indicates that the DMRS port mode is the first mode and a second value of the 1-bit field indicates that the DMRS port mode is the second mode.

In some embodiments of the present application, the indication is indicated by a group common DCI format scrambled with an RNTI specific for DMRS port mode indication.

In some embodiments of the present application, the group common DCI format includes one or more indications, wherein each indication of the one or more indications is for a corresponding UE, and the transmitter is further configured to transmit configuration information indicating the RNTI and configuration information indicating a payload size of the group common DCI format and a start position of the indication for the UE within the group common DCI format.

In some embodiments of the present application, the indication includes a first indication indicating a DMRS port mode for a PDSCH transmission and a second indication indicating a DMRS port mode for a PUSCH transmission, and the processor is further configured to: apply the DMRS port mode for a PDSCH transmission to all the PDSCH transmissions in the active BWP after transmitting the first indication; and apply the DMRS port mode for a PUSCH transmission to all the PUSCH transmissions in the active BWP after transmitting the second indication.

In some embodiments of the present application, the indication indicates a DMRS port mode for both a PDSCH transmission and a PUSCH transmission, and the processor is further configured to: apply the DMRS port mode to all the PDSCH transmissions and all the PUSCH transmissions in the active BWP after transmitting the indication.

In some embodiments of the present application, the RNTI specific for DMRS port mode indication is a DL-RNTI specific for DMRS port mode indication for a PDSCH transmission, and the processor is further configured to: apply the DMRS port mode indicated by the indication to all the PDSCH transmissions in the active BWP after transmitting the indication; or the RNTI specific for DMRS port mode indication is a UL-RNTI specific for DMRS port mode indication for a PUSCH transmission, and the processor is further configured to: apply the DMRS port mode indicated by the indication to all the PUSCH transmissions in the active BWP after transmitting the indication.

In some embodiments of the present application, the indication is a DMRS port mode field in a MAC CE, and the processor is further configured to: apply the DMRS port mode to all the PDSCH transmissions, all the PUSCH transmission, or all the PDSCH transmissions and all the PUSCH transmission in the active BWP after an application time of the MAC CE.

In some embodiments of the present application, the indication indicating the DMRS port mode for the at least one of the PDSCH transmission or the PUSCH transmission is indicated by an RRC signalling for a PDSCH transmission or for a PUSCH transmission, and the processor is further configured to: apply the DMRS port mode for all the PDSCH transmissions or all the PUSCH transmission in the active BWP after transmitting the RRC signalling.

In some embodiments of the present application, all the PDSCH transmissions include at least one of dynamic scheduled PDSCH transmission(s) or SPS PDSCH transmission(s) in the active BWP; or all the PUSCH transmissions include at least one of dynamic scheduled PUSCH transmission(s) or CG PUSCH transmission(s) in the active BWP.

According to some embodiments of the present application, a method performed by a UE may include: receiving at least one DMRS configuration associated with a first mode of DMRS ports and a second mode of DMRS ports; and receiving an indication indicating a DMRS port mode of DMRS port(s) for at least one of a PDSCH or a PUSCH transmission in an active BWP, wherein the DMRS port mode is the first mode or the second mode.

According to some embodiments of the present application, a method performed by a base station (BS) may include: transmitting at least one DMRS configuration associated with a first mode of DMRS ports and a second mode of DMRS ports; and transmitting an indication indicating a DMRS port mode of DMRS port(s) for at least one of a PDSCH or a PUSCH transmission in an active BWP, wherein the DMRS port mode is the first mode or the second mode.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 is a flow chart illustrating an exemplary method for determining DMRS port mode according to some embodiments of the present disclosure;

FIG. 3 illustrates an exemplary method for applying a DMRS port mode to a plurality of PDSCH transmissions according to some embodiments of the present disclosure;

FIG. 4 illustrates an exemplary method for applying a DMRS port mode to a plurality of PDSCH transmissions according to some other embodiments of the present disclosure;

FIG. 5 illustrates an exemplary MAC CE for indicating a DMRS port mode according to some embodiments of the present disclosure;

FIG. 6 illustrates an exemplary DL DMRS configuration indicating a DMRS port mode according to some embodiments of the present disclosure;

FIG. 7 illustrates an exemplary PUSCH configuration indicating a DMRS port mode according to some embodiments of the present disclosure;

FIG. 8 is a flow chart illustrating an exemplary method for determining DMRS port mode according to some other embodiments of the present disclosure; and

FIG. 9 illustrates a simplified block diagram of an exemplary apparatus for determining DMRS port mode according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

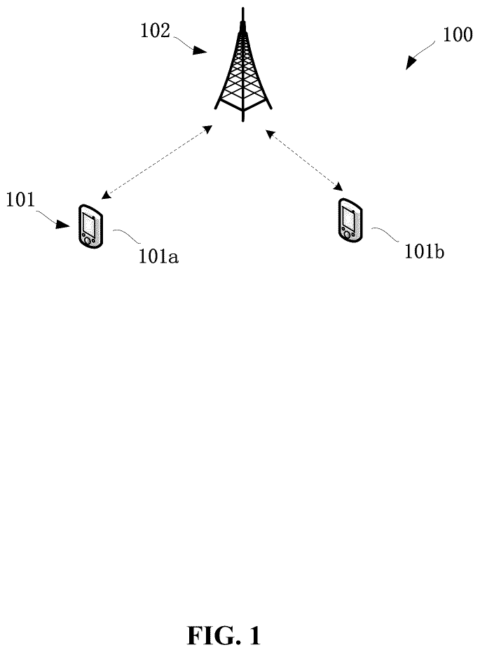

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via UL communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via DL communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In Rel-18 multiple input multiple output (MIMO) topic, it is agreed to study methods for increasing the number of orthogonal DMRS ports to increase the multiplexing capacity of downlink and uplink DMRS from various use cases. For example, in Rel-18 MIMO work item description (WID), the following content is agreed:
Study, and if justified, specify larger number of orthogonal DMRS ports for downlink and uplink multi-user MIMO (MU-MIMO) (without increasing the DM-RS overhead), only for CP-OFDM,
   i. Striving for a common design between DL and UL DMRS;
   ii. Up to 24 orthogonal DMRS ports, where for each applicable DMRS type, the maximum number of orthogonal ports is doubled for both single-symbol and double-symbol DMRS.

In RANI meeting #109, various methods were proposed to increase the number of DMRS ports for PDSCH transmission or PUSCH transmission. These methods may include FD-OCC with length 4 or length 6, frequency division multiplexing (FDM), comb and Time domain-orthogonal cover code (TD-OCC) methods. Compared with a Release 15 (Rel-15) DMRS port, the channel estimation performance of a Release 18 (Rel-18) DMRS port may be poorer in some scenarios. For example, if FDM is adopted in Rel-18 and the delay spread of the channel between a BS and a UE is large, the channel estimation performance of a Rel-18 DMRS port may be poorer since the DMRS density for the Rel-18 DMRS port is reduced. For a Rel-18 UE, it may support both Rel-18 DMRS ports and Rel-15 DMRS ports. The different kinds of DMRS ports may be used in different scenarios based on different requirements. For example, Rel-15 DMRS ports may have better channel estimation performance while Rel-18 DMRS ports may have a greater number of DMRS ports which can increase the multiplexing capacity of DMRS. Given this, to support dynamically switching between Rel-15 DMRS ports and Rel-18 DMRS ports in different scenarios, there is a need for indicating a UE to use which kind of DMRS ports (e.g., Rel-18 DMRS ports or Rel-15 DMRS ports) in different scenarios.

Given the above, embodiments of the present disclosure propose solutions for determining DMRS port mode for DMRS port(s) for PDSCH transmission or PUSCH transmission. For example, embodiments of the present disclosure propose several solutions for indicating a DMRS port mode for DMRS port(s) for PDSCH transmission or PUSCH transmission, wherein the DMRS port mode indicates that the DMRS port(s) is which mode (or kind) of DMRS ports (e.g., Rel-18 DMRS ports or Rel-15 DMRS ports). In addition, embodiments of the present disclosure also propose solutions regarding how to use the DMRS port mode to determine DMRS ports for PDSCH transmission or PUSCH transmission. More details on the embodiments of the present disclosure will be illustrated in the following text in combination with the appended drawings.

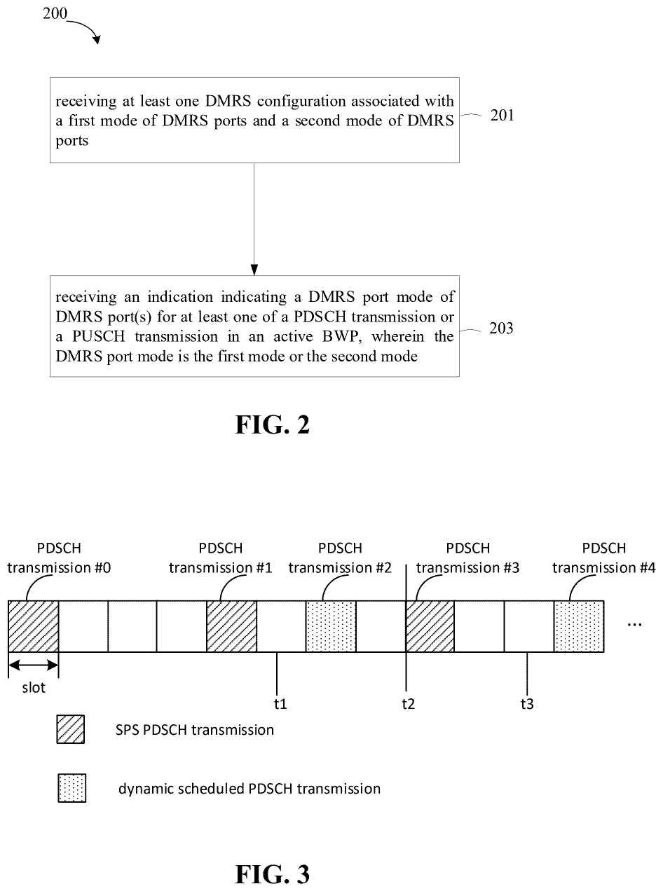

FIG. 2 is a flow chart illustrating an exemplary method 200 for determining DMRS ports according to some embodiments of the present disclosure. The method in FIG. 2 may be implemented by a UE (e.g., UE 101 as shown in FIG. 1).

In the exemplary method shown in FIG. 2, in step 201, the UE may receive at least one DMRS configuration associated with a first mode of DMRS ports and a second mode of DMRS ports from a BS (e.g., BS 102 as shown in FIG. 1).

The first mode of DMRS ports and the second mode of DMRS ports may support different number of DMRS ports. For example, the number of DMRS ports supported by the second mode of DMRS ports may be larger than the number of DMRS ports supported by the first mode of DMRS ports. In some embodiments of the present application, the first mode of DMRS ports may be pre-Rel-18 DMRS ports (e.g., Rel-15 DMRS ports) and the second mode of DMRS ports may be Rel-18 DMRS ports or beyond-Rel-18 DMRS ports (or post-Rel-18 DMRS ports). In some embodiments of the present application, the first mode of DMRS ports and the second mode of DMRS ports may also be referred to as the first kind of DMRS ports and the second kind of DMRS ports.

In some embodiments of the present application, the first mode of DMRS ports and the second mode of DMRS ports for a PDSCH transmission may be associated with different DMRS configurations (i.e., DMRS-DownlinkConfig as specified in TS 38.331). In such embodiments, the at least one DMRS configuration may include the followings.
a first downlink (DL) DMRS configuration associated with the first mode of DMRS ports, for example, downlink DMRS for PDSCH is transmitted according to the first downlink DMRS configuration;
a second downlink DMRS configuration associated with the second mode of DMRS ports, for example, downlink DMRS for PDSCH is transmitted according to the second downlink DMRS configuration.

In some embodiments of the present application, the first mode of DMRS ports and the second mode of DMRS ports for a PUSCH transmission may be associated with different DMRS configurations (i.e., DMRS-UplinkConfig as specified in TS 38.331). In such embodiments, the at least one DMRS configuration may include the followings.
a first uplink (UL) DMRS configuration associated with the first mode of DMRS ports, for example, uplink DMRS for PUSCH is transmitted according to the first uplink DMRS configuration;
a second uplink (UL) DMRS configuration associated with the second mode of DMRS ports, for example, uplink DMRS for PUSCH is transmitted according to the second uplink DMRS configuration.

In the above embodiments, the fields included in the first uplink DMRS configuration associated with the first mode of DMRS ports and the second uplink DMRS configuration associated with the second mode of DMRS ports may have the same or different values. The fields included in the first downlink DMRS configuration associated with the first mode of DMRS ports and the second downlink DMRS configuration associated with the second mode of DMRS ports may have the same or different values.

In some embodiments of the present application, the first mode of DMRS ports and the second mode of DMRS ports for a PDSCH transmission may be associated with the same DMRS configuration. In such embodiments, the at least one DMRS configuration may include:
a downlink DMRS configuration associated with both the first mode of DMRS ports and the second mode of DMRS ports, for example, downlink DMRS for PDSCH is transmitted according to the downlink DMRS configuration.

In some embodiments of the present application, the first mode of DMRS ports and the second mode of DMRS ports for a PUSCH transmission may be associated with the same DMRS configuration. In such embodiments, the at least one DMRS configuration may include:
an uplink DMRS configuration associated with both the first mode of DMRS ports and the second mode of DMRS ports, for example, uplink DMRS for PUSCH is transmitted according to the uplink DMRS configuration.

A DL DMRS configuration may include a field (e.g., denoted as dmrs-Type) indicating a DMRS type (which configures the DMRS pattern in frequency domain, e.g., dmrs-Type=1 or 2) of a downlink DMRS, a field (e.g., denoted as maxLength) indicating a maximum length of the downlink DMRS (which means that DMRS occupies the number of consecutive symbols in time domain, e.g., maxLength=1 or 2), and other fields for configuring the downlink DMRS. An example of fields included in a DL DMRS configuration may refer to DMRS-DownlinkConfig as specified in TS 38.331.

A UL DMRS configuration may include a field (e.g., denoted as dmrs-Type) indicating a DMRS type (which configures the DMRS pattern in frequency domain, e.g., dmrs-Type=1 or 2) of an uplink DMRS, a field (e.g., denoted as maxLength) indicating a maximum length of the uplink DMRS (which means that DMRS occupies the number of consecutive symbols in time domain, e.g., maxLength=1 or 2), a field including parameters when a transform precoder is enabled, a field including parameters when a transform precoder is disabled, and other fields for configuring the uplink DMRS. An example of fields included in a UL DMRS configuration may refer to DMRS-UplinkConfig as specified in TS 38.331.

If the first mode of DMRS ports and the second mode of DMRS ports for a PDSCH or a PUSCH transmission are associated with different DMRS configurations, the values of the above fields included in the different DMRS configurations may be same or may be different.

In step 203, the UE may receive an indication indicating a DMRS port mode of DMRS port(s) for at least one of a PDSCH transmission or a PUSCH transmission in an active BWP from the BS. The DMRS port mode may be the first mode or the second mode as stated above.

In some embodiments of the present application, the UE may determine DMRS port(s) for PDSCH transmission(s) or PUSCH transmission(s) based on the DMRS port mode and the at least one DMRS configuration. The specific operation will be described in detail below.

### Embodiment 1

In embodiment 1, the DMRS port mode of DMRS port(s) may be indicated by a UE specific DCI format or a CG configuration. Based on the different indicating methods, embodiment 1 may further include embodiment 1-1, embodiment 1-2, and embodiment 1-3.

### Embodiment 1-1

In embodiment 1-1, the DMRS port mode may be explicitly indicated by a field (e.g., denoted as a DMRS port mode field) in a non-fallback DCI format for scheduling or activating a PDSCH transmission or a PUSCH transmission or in a CG configuration. In such embodiment, the indication indicating a DMRS port mode of DMRS port(s) for the PDSCH transmission or the PUSCH transmission may be the DMRS port mode field in a non-fallback DCI format or in a CG configuration.

In some embodiments, the DMRS port mode field may be a new field added in a non-fallback DCI format.

In some embodiments, the DMRS port mode field may be a 1-bit field. The first value (e.g., 0) of the 1-bit field may indicate that the DMRS port mode of DMRS port(s) for a PDSCH transmission or a PUSCH transmission is the first mode and a second value (e.g., 1) of the 1-bit field may indicate that the DMRS port mode of DMRS port(s) for a PDSCH transmission or a PUSCH transmission is the second mode.

For a PDSCH transmission, a non-fallback DCI format may be DCI format 1_1 or DCI format 1_2 as specified in 3GPP standard documents. For a PUSCH transmission, a non-fallback DCI format may be DCI format 0_1 or DCI format 0_2 as specified in 3GPP standard documents.

In some embodiments, whether the DMRS port mode field is included in a non-fallback DCI format may be configured by an RRC signalling. For example, if a UE supports both the first mode of DMRS ports and the second mode of DMRS ports and support dynamic switching between the first mode of DMRS port and the second mode of DMRS port, the UE may receive an RRC signalling indicating that the DMRS port mode field is included in a non-fallback DCI format.

In some cases of embodiment 1-1, the non-fallback DCI format may be a non-fallback DCI format for scheduling a PDSCH transmission (or a PUSCH transmission) or a PDSCH retransmission (or a PUSCH retransmission). In some other cases of embodiment 1-1, for a type 2 CG PUSCH transmission (or a SPS PDSCH transmission), the non-fallback DCI format may be a non-fallback DCI format for activating the type 2 CG PUSCH transmission (or activating the SPS PDSCH transmission). In some cases of embodiment 1-1, for a type 1 CG PUSCH transmission, the field is included in a CG configuration to indicate the DMRS port mode for the type 1 CG PUSCH transmission.

In the above cases, for a PDSCH transmission or a PUSCH transmission, the UE may determine an antenna port table based on the DMRS port mode indicated by the DMRS port mode field and a DMRS configuration of the at least one DMRS configuration for the PDSCH transmission (or the PUSCH transmission), wherein the DMRS configuration may be associated with the DMRS port mode indicated by the DMRS port mode field. Then, the UE may determine DMRS port(s) for the PDSCH transmission (or the PUSCH transmission) based on the antenna port table and an antenna port field included in the non-fallback DCI format.

In some embodiments of the present application, the first mode of DMRS ports and the second mode of DMRS ports may be associated with different antenna port tables. For example, the first mode of DMRS ports may be associated with a first set of antenna port tables, each antenna port table in the first set of antenna port tables may be associated with a corresponding DMRS configuration and used for determining DMRS ports of the first mode of DMRS ports. The second mode of DMRS ports may be associated with a second set of antenna port tables different from the first set of antenna port tables, each antenna port table in the second set of antenna port tables may be associated with a corresponding DMRS configuration and used for determining DMRS ports of the second mode of DMRS ports.

Then, based on the DMRS port mode and the DMRS configuration, the UE may determine, from the first set of antenna port tables or the second set of antenna port tables, an antenna port table.

After determining the antenna port table, the UE may determine DMRS port(s) for the PDSCH transmission (or the PUSCH transmission) based on the antenna port table and the antenna port field. For example, the antenna port field may indicate an index of an entry in the antenna port table, and the entry may indicate one or more DMRS ports. The UE may determine the one or more DMRS ports to be DMRS port(s) for the PDSCH transmission (or the PUSCH transmission).

For example, when the first mode of DMRS ports are Rel-15 DMRS ports and the second mode of DMRS ports are Rel-18 DMRS ports, additional antenna port tables associated with Rel-18 DMRS ports may be specified in 3GPP standard documents for Rel-18 DMRS port indication. In such example, the DMRS port mode may indicate a UE whether a Rel-15 antenna port table or a newly added Rel-18 antenna port table is used to determine DMRS port.

In some other embodiments of the present application, the first mode of DMRS ports and the second mode of DMRS ports may share the same antenna port tables, wherein each antenna port table may be associated with a corresponding DMRS configuration of the at least one DMRS configuration and used for determining DMRS ports of the first mode of DMRS ports and DMRS ports of the second mode of DMRS ports. In some cases, a part of entries in an antenna port table may be used for determining DMRS ports of the first mode of DMRS ports and all the entries of the antenna port table may be used for determining DMRS ports of the second mode of DMRS ports.

Then, based on the DMRS port mode and the DMRS configuration, the UE may determine an antenna port table.

After determining the antenna port table, the UE may determine DMRS port(s) for the PDSCH transmission (or the PUSCH transmission) based on the antenna port table and the antenna port field. For example, the antenna port field may indicate an index of an entry in the antenna port table, and the entry may indicate one or more DMRS ports. In some cases, if the DMRS port mode is the first mode, the entry indicated by the antenna port field may be an entry within a part of entries of the antenna port table; if the DMRS port mode is the second mode, the entry indicated by the antenna port field may be any entry in the antenna port table. The UE may determine the one or more DMRS ports to be DMRS port(s) for the PDSCH transmission (or the PUSCH transmission).

For example, when the first mode of DMRS ports are Rel-15 DMRS ports and the second mode of DMRS ports are Rel-18 DMRS ports, additional entries may be added to the antenna port tables dedicated for Rel-18 DMRS ports. When the DMRS port mode is Rel-15 DMRS port, only the entries including DMRS ports specified in Rel-15 can be indicated by the antenna port field. When the DMRS port mode is Rel-18 DMRS port, all the entries of the antenna port tables can be indicated by the antenna port field.

In embodiment 1-1, a bit width of the antenna port field included in the non-fallback DCI format may be a maximum bit width of a bit width required to indicate antenna port(s) (i.e., DMRS port(s)) for the first mode of DMRS ports and a bit width required to indicate antenna port(s) (i.e., DMRS port(s)) for the second mode of DMRS ports.

For example, it is assumed that: a DCI format 0_1 schedules a CP-OFDM (i.e., the transform precoder is disabled) PUSCH transmission and indicates the rank of the PUSCH transmission is 2; a 1-bit DMRSPortMode field is added in the DCI format 0_1 to indicate the DMRS port mode of DMRS port(s) for the scheduled PUSCH transmission for a UE; an antenna port field in the DCI format 0_1 indicates value “011.”

In addition, it is also assumed that: the UE supports Rel-18 DMRS ports and Rel-15 DMRS ports and supports dynamically switching between Rel-18 DMRS ports and Rel-15 DMRS ports; and a first DMRS configuration (e.g., DMRS configuration #1) is associated with Rel-18 DMRS ports and a second DMRS configuration (e.g., DMRS configuration #2) is associated with Rel-15 DMRS ports, for example, the DMRS configuration #1 and DMRS configuration #2 may both indicate that dmrs-Type=1 and maxLength=1.

Assuming that new antenna port tables are specified for Rel-18 DMRS ports. For example, Table 1 may be an antenna port table with DMRS configuration #2 and associated with Rel-15 DMRS ports (e.g., for Rel-15 DMRS port indication), which is the same as Table 7.3.1.1.2-9 in TS 38.212. Table 2 may be an exemplary antenna port table with DMRS configuration #1 and associated with Rel-18 DMRS ports (e.g., for Rel-18 DMRS port indication).

TABLE 1
Rel-15 Antenna port(s), transform precoder is disabled, dmrs-
Type = 1, maxLength = 1, rank = 2

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

TABLE 2
Rel-18 Antenna port(s), transform precoder is disabled, dmrs-
Type = 1, maxLength = 1, rank = 2

| | Number of DMRS CDM | DMRS |
|---|---|---|
| Value | group(s) without data | port(s) |
| 0 | 2 | 0, 1 |
| 1 | 2 | 2, 3 |
| 2 | 2 | 0, 2 |
| 3 | 2 | 8, 9 |
| 4 | 2 | 10, 11 |
| 5 | 2 | 8, 10 |
| 6 | 2 | 0, 8 |
| 7 | 2 | 0, 10 |

Referring to Table 1 and Table 2, when the DMRSPortMode field equals “0,” it means that the indicated DMRS port(s) for the scheduled PUSCH is Rel-15 DMRS port(s) and Table 1 will be used for DMRS port indication. Based on “011” indicated by the antenna port field, the UE may determine that DMRS port 0 and DMRS port 2 in the 4th entry in Table 1 will be used for the PUSCH transmission.

When the DMRSPortMode field equals “1,” it means that the indicated DMRS port(s) for the scheduled PUSCH is Rel-18 DMRS port(s) and Table 2 will be used for DMRS port indication. Based on “011” indicated by the antenna port field, the UE may determine that DMRS port 8 and DMRS port 9 in the 4th entry in Table 2 will be used for the PUSCH transmission.

In some cases of embodiment 1-1, for a PDSCH transmission (or a PUSCH transmission) scheduled by a fallback DCI format, the DMRS port mode is the first mode for the PDSCH transmission (or the PUSCH transmission). For a PDSCH transmission, a fallback DCI format may be DCI format 1_0 as specified in 3GPP standard documents. For a PUSCH transmission, a fallback DCI format may be DCI format 0_0 as specified in 3GPP standard documents.

In such cases, the fallback DCI format does not include a field indicating a DMRS port mode. In response to receiving the fallback DCI format scheduling a PDSCH transmission (or a PUSCH transmission), the UE may determine that a DMRS port mode for DMRS port(s) for the PDSCH transmission (or a PUSCH transmission) is the first mode (i.e., Rel-15 DMRS ports).

### Embodiment 1-2

In embodiment 1-2, the first mode of DMRS ports and the second mode of DMRS ports may share the same antenna port tables. The DMRS port mode of DMRS port(s) may be implicitly indicated in a non-fallback DCI format for a PDSCH transmission or a PUSCH transmission or in a CG configuration. For example, the DMRS port mode may be indicated by an antenna port field included in a non-fallback DCI format or in a CG configuration. In such embodiments, the indication indicating a DMRS port mode may be an antenna port field included in a non-fallback DCI format or in a CG configuration.

For a PDSCH transmission, a non-fallback DCI format may be DCI format 1_1 or DCI format 1_2 as specified in 3GPP standard documents. For a PUSCH transmission, a non-fallback DCI format may be DCI format 0_1 or DCI format 0_2 as specified in 3GPP standard documents.

In some cases of embodiment 1-2, the non-fallback DCI format may be a non-fallback DCI format for scheduling a PDSCH transmission (or a PUSCH transmission) or a PDSCH retransmission (or a PUSCH retransmission). In some other cases of embodiment 1-2, for a type 2 CG PUSCH transmission (or a SPS PDSCH transmission), the non-fallback DCI format may be a non-fallback DCI format for activating the type 2 CG PUSCH transmission (or the SPS PDSCH transmission). In some cases of embodiment 1-2, for a type 1 CG PUSCH transmission, the field is included in a CG configuration to indicate the DMRS port mode for the type 1 CG PUSCH transmission.

In the above cases, for a PDSCH transmission or a PUSCH transmission, the UE may determine the DMRS port mode for the PDSCH transmission or the PUSCH transmission based on the antenna port field. The following embodiments provide several methods for determining the DMRS port mode based on the antenna port field.

In some embodiments, an antenna port table shared by the first mode of DMRS ports and the second mode of DMRS ports may include a set of entries (e.g., denoted as set #A) dedicated for indicating the first mode of DMRS ports and a set of entries (demoted as set #B) dedicated for indicating the second mode of DMRS ports, wherein set #A are different from set #B (e.g., set #A and set #B do not have any same entry). For example, when the first mode of DMRS ports are Rel-15 DMRS ports and the second mode of DMRS ports are Rel-18 DMRS ports, additional entries may be added to the antenna port tables for Rel-18 DMRS ports. The legacy DMRS ports entries in the antenna port tables may be dedicated for Rel-15 DMRS port indication and newly added additional entries may be dedicated for Rel-18 DMRS port indication. Then, the DMRS port mode may be indicated implicitly by an index of an entry indicated by the antenna port field.

For example, based on the DMRS configuration for the first mode of DMRS ports and the second mode of DMRS ports, the UE may determine an antenna port table shared by the first mode of DMRS ports and the second mode of DMRS ports. The antenna port table may include first set of entries associated with the first mode of DMRS ports and a second set of entries associated with the second mode of DMRS ports. The antenna port field may indicate an index of an entry in the antenna port table, wherein the entry may indicate the DMRS port(s) and the DMRS port mode. Then, the UE may determine the DMRS port mode of the DMRS port(s) based on the entry index of the entry indicated by the antenna port field. For example, in the case that the entry index indicates that the entry belongs to the first set of entries, the UE may determine that the DMRS port mode of the DMRS ports in the entry is the first mode; in the case that the entry index indicates that the entry belongs to the second set of entries, the UE may determine that the DMRS port mode of the DMRS ports in the entry is the second mode.

In some other embodiments, the FDM method or comb method may be adopted to increase the number of DMRS ports. Then, the DMRS port mode may be implicitly indicated by the column “Number of DMRS CDM group(s) without data” in a DMRS port table (i.e., antenna port table) since more CDM groups may be introduced for increasing the number of DMRS ports.

For example, based on the DMRS configuration for the first mode of DMRS ports and the second mode of DMRS ports, the UE may determine an antenna port table shared by the first mode of DMRS ports and the second mode of DMRS ports. The antenna port field may indicate an index of an entry in the antenna port table. Then, the UE may determine the DMRS port mode of the DMRS port(s) in the entry based on the number of DMRS CDM groups without data indicated by the entry.

For example, in the case that the number of DMRS CDM groups without data is not larger than 2 for DMRS type 1 or not larger than 3 for DMRS type 2, the UE may determine that the DMRS port mode of the DMRS port(s) is the first mode; in the case that the number of DMRS CDM groups without data is larger than 2 for DMRS type 1 or larger than 3 for DMRS type 2, the UE may determine that the DMRS port mode of the DMRS port(s) is the second mode.

In some other embodiments, the FD-OCC with length 4 or length 6 may be adopted to increase the number of DMRS ports.

In some cases, one column may be added in an antenna port table to indicate the length of FD-OCC. Then, the UE may determine the DMRS port mode based on the length of FD-OCC.

For example, based on the DMRS configuration for the first mode of DMRS ports and the second mode of DMRS ports, the UE may determine an antenna port table shared by the first mode of DMRS ports and the second mode of DMRS ports. The antenna port field may indicate an index of an entry in the antenna port table. Then, the UE may determine the DMRS port mode of the DMRS port(s) in the entry based on a length of FD-OCC indicated by the entry.

For example, in the case that the length of FD-OCC is 2, the UE may determine that the DMRS port mode of the DMRS port(s) in the entry is the first mode; in the case that the number of DMRS CDM group is larger than 2 (e.g., 4 or 6 if FD-OCC with length 4 or 6 is adopted in Rel-18 to increase the number of DMRS ports), the UE may determine that the DMRS port mode of the DMRS port(s) in the entry is the second mode

In some other cases, one column may be added in an antenna port table to indicate the number of DMRS ports within a CDM group. Then, the UE may determine the DMRS port mode based on the number of DMRS ports within a CDM group.

For example, based on the DMRS configurations for the first mode of DMRS ports and the second mode of DMRS ports, the UE may determine an antenna port table shared by the first mode of DMRS ports and the second mode of DMRS ports. The antenna port field may indicate an index of an entry in the antenna port table. Then, the UE may determine the DMRS port mode of the DMRS port(s) in the entry based on the number of DMRS ports within a CDM group indicated by the entry.

For example, in the case that the number of DMRS ports within a CDM group is 2 for single-symbol DMRS or 4 for double-symbol DMRS, the UE may determine that the DMRS port mode of the DMRS port(s) is the first mode; in the case that the number of DMRS ports within a CDM group is 4 for single-symbol DMRS or is 8 for double-symbol DMRS, the UE may determine that the DMRS port mode of the DMRS port(s) is the second mode.

For example, it is assumed that: a DCI format 1_1 schedules a PDSCH transmission; a DMRS configuration (e.g., DMRS configuration #1) is associated with Rel-18 DMRS ports and Rel-15 DMRS ports, for example, the DMRS configuration #1 may indicate that dmrs-Type=1 and maxLength=1; and FD-OCC of length 4 is used to increase the number of DMRS ports in Rel-18.

In addition, it is also assumed that: Rel-18 DMRS ports and Rel-15 DMRS ports share the same DMRS port tables. For example, based on the same DMRS configuration #1, the UE may determine an antenna port table (e.g., Table 3 shown below) shared by Rel-18 DMRS ports and Rel-15 DMRS ports.

TABLE 3
Antenna port(s) (1000 + DMRS port), dmrs-
Type = 1, maxLength = 1

| One Codeword: | | | |
|---|---|---|---|
| Codeword 0 enabled, | | | |
| Codeword 1 disabled | | | |
| | Number of | | Length of |
| | DMRS CDM | | FD-OCC |
| | group(s) | DMRS | (new |
| Value | without data | port(s) | added) |
| 0 | 1 | 0 | 2 |
| 1 | 1 | 1 | 2 |
| 2 | 1 | 0, 1 | 2 |
| 3 | 2 | 0 | 2 |
| 4 | 2 | 1 | 2 |
| 5 | 2 | 2 | 2 |
| 6 | 2 | 3 | 2 |
| 7 | 2 | 0, 1 | 2 |
| 8 | 2 | 2, 3 | 2 |
| 9 | 2 | 0-2 | 2 |
| 10 | 2 | 0-3 | 2 |
| 11 | 2 | 0, 2 | 2 |
| 12 | 2 | 0, 1 | 4 |
| 14 | 2 | 2, 3 | 4 |
| 14 | 2 | 8, 9 | 4 |
| 15 | 2 | 10, 11 | 4 |

Referring to Table 3, the column “Length of FD-OCC” may be a newly added column compared with the antenna port tables in Rel-15. Then, the UE may determine the DMRS port mode based on the length of FD-OCC.

For example, if antenna port field in DCI format 1_1 equals “0111”, the UE may determine that DMRS port 0 and DMRS port 1 in the 8th entry in Table 3 will be used for the PDSCH transmission and determine that the indicated DMRS ports (i.e., DMRS port 0 and DMRS port 1) are Rel-15 DMRS ports because the length of FD-OCC in the 8th entry is 2. In another example, if antenna port field in DCI format 1_1 equals “1100”, the UE may determine that DMRS port 0 and DMRS port 1 in the 13th entry in Table 3 will be used for the PDSCH transmission and determine that the indicated DMRS ports (i.e., DMRS port 0 and DMRS port 1) are Rel-18 DMRS ports because the length of FD-OCC in the 13th entry is 4.

In some cases of embodiment 1-2, for a PDSCH transmission (or a PUSCH transmission) scheduled by a fallback DCI format, the DMRS port mode is the first mode for the PDSCH transmission (or the PUSCH transmission). For a PDSCH transmission, a fallback DCI format may be DCI format 1_0 as specified in 3GPP standard documents. For a PUSCH transmission, a fallback DCI format may be DCI format 0_0 as specified in 3GPP standard documents.

In such cases, the fallback DCI format does not include a field indicating a DMRS port mode. In response to receiving the fallback DCI format scheduling a PDSCH transmission (or a PUSCH transmission), the UE may determine that a DMRS port mode for DMRS port(s) for the PDSCH transmission (or a PUSCH transmission) is the first mode (i.e., Rel-15 DMRS ports).

In some cases of the present application, if a channel quality between a UE and a BS becomes bad and the DMRS port(s) of a dynamic scheduled PDSCH transmission needs to fall back to Rel-15 DMRS port(s), the DMRS port(s) of other scheduled PDSCH transmissions or SPS PDSCH transmissions may also probably need to fall back to Rel-15 DMRS port(s). In some other cases of the present application, if a channel quality of a DL channel between a UE and a BS becomes bad, it is probable that a channel quality of a UL channel also becomes bad, and the DMRS port(s) of a dynamic scheduled PUSCH transmission or a CG PUSCH transmission may also need to fall back to Rel-15 DMRS port(s).

Given this, embodiment 1-3 may provide a method in which a DMRS port mode may apply to a plurality of PDSCH transmissions or PUSCH transmissions.

### Embodiment 1-3

In embodiment 1-3, the indication indicating a DMRS port mode may be a field (e.g., denoted as a DMRS port mode field) in a non-fallback DCI format for scheduling a PDSCH transmission or a PUSCH transmission. For a PDSCH transmission, a non-fallback DCI format may be DCI format 1_1 or DCI format 1_2 as specified in 3GPP standard documents. For a PUSCH transmission, a non-fallback DCI format may be DCI format 0_1 or DCI format 0_2 as specified in 3GPP standard documents.

In some embodiments, the DMRS port mode field may be a new field added in a non-fallback DCI format.

In some embodiments, the DMRS port mode field may be a 1-bit field. The first value (e.g., 0) of the 1-bit field may indicate that the DMRS port mode is the first mode and a second value (e.g., 1) of the 1-bit field may indicate that the DMRS port mode is the second mode.

After receiving the indication indicating a DMRS port mode, the UE may apply to DMRS port mode to all the PDSCH transmissions or all the PUSCH transmissions in the active BWP (e.g., in the active BWP in a serving cell) after an application time of the indication, which means that the UE may determine that the DMRS port(s) of all PDSCH transmission or all PUSCH transmission is the first mode of DMRS ports or the second mode of DMRS ports by the same DMRS port mode. The application time may be determined based on the following methods.

In some cases, the non-fallback DCI format may schedule a PDSCH transmission. After receiving the non-fallback DCI format, the UE may transmit the HARQ-ACK information (e.g., acknowledgement (ACK) or negative acknowledgement (NACK)) of the PDSCH transmission to the BS. The HARQ-ACK information of the PDSCH transmission may be used as an acknowledgement of the non-fallback DCI format.

Then, the UE apply the DMRS port mode to all the PDSCH transmissions after an application time of the indication (e.g., DMRS port field). In some embodiments, the DMRS port mode may be used until another application time of another indication to indicate another DMRS port mode. The application time may be a number of time units after the last symbol of a PUCCH carrying the HARQ-ACK information for the PDSCH transmission. All the PDSCH transmissions include at least one of dynamic scheduled PDSCH transmission(s) or SPS PDSCH transmission(s) in the active BWP.

In the above cases, applying the DMRS port mode to all the PDSCH transmissions means using the DMRS port mode to determine a same set of DMRS port tables for all the PDSCH transmissions (e.g., the set of DMRS port tables associated with Rel-15 DMRS ports or the set of DMRS port tables associated with Rel-18 DMRS ports). The determined DMRS port tables may be used for determining DMRS port(s) for all the PDSCH transmissions. For example, for a dynamic scheduled PDSCH transmission, the UE may determine DMRS port(s) based on a DMRS port table (e.g., denoted as DMRS port table #1) in the set of DMRS port tables associated with the DMRS port mode and an antenna port field included a DCI format (which is different from the DCI format indicating the DMRS port mode). For a SPS PDSCH transmission, the UE may determine DMRS port(s) based on another DMRS port table (e.g., denoted as DMRS port table #2) in the set of DMRS port tables associated with the DMRS port mode and an antenna port field included the DCI format indicating the DMRS port mode. The determined DMRS port table #1 and DMRS port table #2 may be same or different.

In some cases, the non-fallback DCI format may schedule a PUSCH transmission. In such cases, the BS may transmit another DCI format scheduling another PUSCH transmission with a same HARQ process number and having a toggled NDI field value as an acknowledgement of the non-fallback DCI format.

Then, the UE may apply the DMRS port mode to all the PUSCH transmissions in the active BWP after an application time of the indication (e.g., DMRS port field). In some embodiments, the DMRS port mode may be used until another application time of another indication to indicate another DMRS port mode. The application time is a number of time units after the last symbol of another DCI format scheduling another PUSCH transmission with a same HARQ process number and having a toggled NDI field value. All the PUSCH transmissions include at least one of dynamic scheduled PUSCH transmission(s) or CG PUSCH transmission(s) in the active BWP.

In the above cases, applying the DMRS port mode to all the PUSCH transmissions means using the DMRS port mode to determine a same set of DMRS port tables for all the PUSCH transmissions in the active BWP (e.g., the set of DMRS port tables associated with Rel-15 DMRS ports or the set of DMRS port tables associated with Rel-18 DMRS ports). The determined DMRS port tables may be used for determining DMRS port(s) for all the PUSCH transmissions in the active BWP. For example, for a dynamic scheduled PUSCH transmission, the UE may determine DMRS port(s) based on a DMRS port table (e.g., denoted as DMRS port table #1′) in the set of DMRS port tables associated with the DMRS port mode and an antenna port field included a DCI format (which is different from the DCI format indicating the DMRS port mode). For a CG PUSCH transmission, the UE may determine DMRS port(s) based on another DMRS port table (e.g., denoted as DMRS port table #2′) in the set of DMRS port tables associated with the DMRS port mode and an antenna port field included the DCI format indicating the DMRS port mode.

In the above cases, a time unit may be a slot, a symbol, a sub-slot, 1 ms, etc.

In some embodiments, the number of time units may be configured by a higher layer (e.g., a layer higher than a physical layer) signalling.

In some embodiments, the number of time units may be not configured for the UE, then the UE may use a default value (e.g., 0) as the number of time units. In such embodiments, the UE may apply a DMRS port mode to all the PDSCH transmissions or all the PUSCH transmissions in the active BWP (e.g., in the active BWP in a serving cell) in response to (e.g., after or upon) receiving the indication.

FIG. 3 illustrates an exemplary method for applying a DMRS port mode to a plurality of PDSCH transmissions according to some embodiments of the present disclosure.

Referring to FIG. 3, it illustrates five PDSCH transmissions as an example, wherein PDSCH transmissions #0, #1, #3 are different transmission occasion of a SPS PDSCH transmission with a periodicity of 4 slots. PDSCH transmissions #2 and #4 are two dynamic scheduled PDSCH transmissions.

It is assumed that PDSCH transmissions #0 and #1 are transmitted by a BS with Rel-15 DMRS port(s). At a time point t1, a DCI format 1_1 (e.g., denoted as DCI #0) schedules PDSCH transmission #2 and indicates that the DMRS port mode is Rel-18 DMRS port(s). At a time point t3, a DCI format 1_2 (e.g., denoted as DCI #1) schedules PDSCH transmission #4. Assuming that UE successfully decodes DCI format #0 and the application time of the DMRS port mode is t2. Then, PDSCH transmissions #3 and #4 after t2 will use Rel-18 DMRS ports afterwards

Besides the UE specific DCI format, a group common DCI format may also be used to indicate the DMRS port mode for a UE. In Rel-18, DMRS ports may be multiplexed between Rel-18 UEs or may be multiplexed between Rel-15 UEs and Rel-18 UEs. In some scenarios, more than one UE may need to switch/update the DMRS port mode simultaneously. Then, a group common DCI format may be introduced to effectively indicate the DMRS port mode for multiple UEs. The following embodiment 2 illustrates how to indicate the DMRS port mode by a group common DCI format.

### Embodiment 2

In embodiment 2, the DMRS port mode of DMRS port(s) may be indicated by a group common DCI format. Based on the different indicating methods, embodiment 2 may further include embodiment 2-1 and embodiment 2-2.

### Embodiment 2-1

In embodiment 2-1, the group common DCI may indicate DMRS port mode for PDSCH transmission and PUSCH transmission separately.

### Embodiment 2-1-1

In embodiment 2-1-1, a group common DCI format scrambled with a dedicated RNTI, e.g., DMRS-RNTI, may be introduced to indicate the DMRS port mode.

In such embodiments, the UE may receive a group common DCI format scrambled with an RNTI (e.g., DMRS-RNTI) specific or dedicated for DMRS port mode indication.

The group common DCI format may include one or more indications, wherein each indication of the one or more indications is for a corresponding UE. Each indication may include an indication indicating a DMRS port mode for PDSCH transmission for a corresponding UE and another indication indicating a DMRS port mode for PUSCH transmission for the corresponding UE.

For example, the group common DCI format may include the following information: DMRSPortMode indication #1, DMRSPortMode indication #2, . . . , DMRSPortMode indication #N, wherein DMRSPortMode indication #1 is for UE #1 DMRSPortMode indication #2 is for UE #2, . . . , DMRSPortMode indication #N is for UE #N.

Each DMRSPortMode indication may include 2 bits, wherein one bit is used for indicating a DMRS port mode for PDSCH transmission for a corresponding UE, and the other bit is used for indicating a DMRS port mode for PUSCH transmission for the corresponding UE. For example, each bit of DMRSPortMode indication equals “O” means that the DMRS port mode is Rel-15 DMRS port(s) and the bit equals “1” means that the DMRS port mode is Rel-18 DMRS port(s).

Before receiving the group common DCI format, the UE may receive configuration information indicating the RNTI specific or dedicated for DMRS port mode indication, such that it may use the RNTI to decode a group common DCI format for DMRS port mode indication.

The UE may also receive configuration information indicating a payload size of a group common DCI format and a start position (e.g., the start bit) of the indication for the UE within the group common DCI format from the BS, such that the UE may know which indication included in the group common DCI format is for the UE. In some embodiments, the start position is multiples of 2 bits.

Then, after receiving a group common DCI format scrambled with an RNTI (e.g., DMRS-RNTI) specific or dedicated for DMRS port mode indication, the UE may determine an indication for it based on the above configuration information, the indication may include a first indication indicating a DMRS port mode (e.g., denoted as DMRS port mode #1) for DMRS port(s) for a PDSCH transmission and a second indication indicating a DMRS port mode (e.g., denoted as DMRS port mode #2) for DMRS port(s) for a PUSCH transmission. The UE may apply DMRS port mode #1 to all the PDSCH transmissions in the active BWP after receiving the first indication. Alternatively or additionally, the UE may apply DMRS port mode #2 to all the PUSCH transmissions in the active BWP after receiving the second indication.

In some embodiments, the UE may apply DMRS port mode #1 to all the PDSCH transmissions or apply DMRS port mode #2 to all the PUSCH transmissions in the active BWP after an application time of the group common DCI format. The application time is a number of time units after the UE receives the group common DCI format. A time unit may be a slot, a symbol, a sub-slot, 1 ms, etc.

In some embodiments, the number of time units may be configured by a higher layer (e.g., a layer higher than a physical layer) signalling. In some embodiments, the number of time units may be not configured for the UE, then the UE may use a default value (e.g., 0) as the number of time units. In such embodiments, the UE may apply to DMRS port mode to all the PDSCH transmissions or all the PUSCH transmissions in the active BWP (e.g., in the active BWP in a serving cell) in response to (e.g., after or upon) receiving the group common DCI format.

### Embodiment 2-1-2

In embodiment 2-1-2, to indicate the DMRS port mode for DMRS port(s) for PDSCH and DMRS port(s) for PUSCH transmissions separately, the group common DCI can be scrambled by different dedicated RNTIs (DL-DMRS-RNTI and UL-DMRS-RNTI) for PDSCH transmission and PUSCH transmission, respectively.

In such embodiments, the UE may receive a group common DCI format scrambled with a DL-RNTI specific for DMRS port mode indication for a PDSCH transmission or a UL-RNTI specific for DMRS port mode indication for a PUSCH transmission.

In such embodiments, the group common DCI format may also include one or more indications as in embodiment 2-1-1. The difference is that each indication may indicate a DMRS port mode for PDSCH transmission in the case that the group common DCI format is scrambled with the DL-RNTI or indicate a DMRS port mode for PUSCH transmission in the case that the group common DCI format scrambled with the UL-RNTI.

For example, each indication may be 1 bit, wherein the bit equals “O” means that the DMRS port mode is Rel-15 DMRS port(s) and the bit equals “1” means that the DMRS port mode is Rel-18 DMRS port(s).

Before receiving the group common DCI format, the UE may also receive configuration information indicating a DL-RNTI dedicated for DMRS port mode indication for PDSCH transmission and a UL-RNTI dedicated for DMRS port mode indication for PUSCH transmission and configuration information indicating a payload size of a group common DCI format and a start position (e.g., the start bit) of the indication for the UE within the group common DCI format from the BS.

Then, after receiving the group common DCI format scrambled with the DL-RNTI or the UL-RNTI, the UE may determine an indication for it based on the above configuration information.

In the case that the group common DCI format is scrambled with the DL-RNTI specific for DMRS port mode indication for a PDSCH transmission, the UE may apply the DMRS port mode indicated by the indication to all the PDSCH transmissions in the active BWP after receiving the indication; in the case that group common DCI format is scrambled with the UL-RNTI specific for DMRS port mode indication for a PUSCH transmission, the UE may apply the DMRS port mode indicated by the indication to all the PUSCH transmissions in the active BWP after receiving the indication.

In some embodiments, the UE may apply DMRS port mode to all the PDSCH transmissions or all the PUSCH transmissions in the active BWP after an application time of the group common DCI format. The definitions of the application time in embodiment 2-1-1 may apply here.

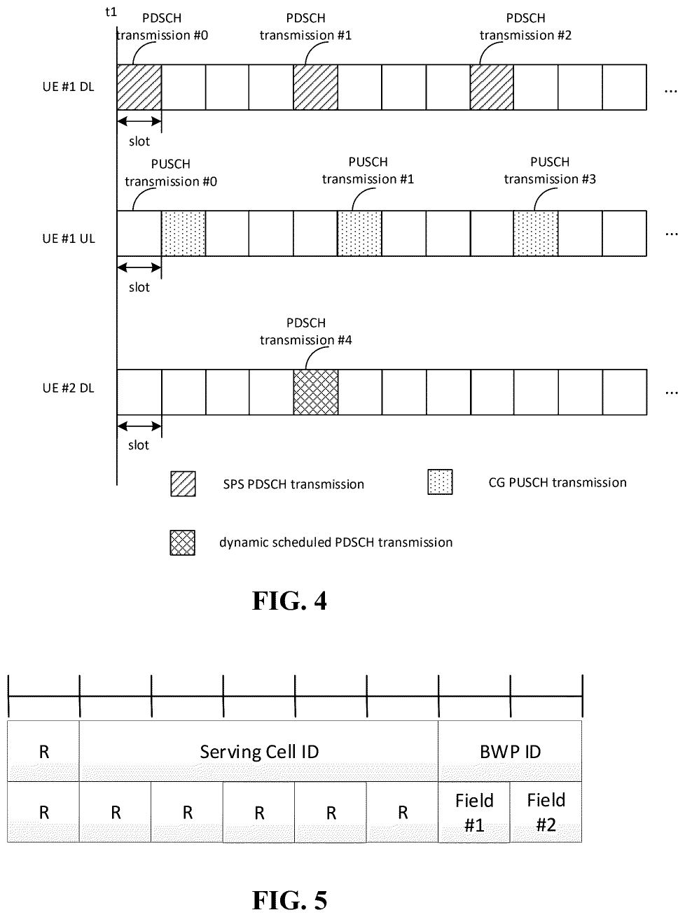

FIG. 4 illustrates an exemplary method for applying a DMRS port mode to a plurality of PDSCH transmissions according to some other embodiments of the present disclosure.

Referring to FIG. 4, it illustrates two UEs (e.g., denoted as UE #1 and UE #2). It is assumed that PDSCH transmissions #0, #1, #2 are three transmission occasions of a SPS PDSCH transmission with a periodicity of 4 slots transmitted from a BS to UE #1, PUSCH transmissions #0, #1, #2 are three transmission occasions of a CG PUSCH transmission with a periodicity of 4 slots transmitted from UE #1 to the BS, the BS also schedules a PDSCH transmission #4 to UE #2.

It is also assumed that a new group common DCI format (e.g., a group common DCI format scrambled by a dedicated RNTI) is introduced to indicate the DMRS port mode for multiple UEs. For example, the payload size of the new group common DCI format is configured as 8 bits. Accordingly, the new group common DCI format includes 4 indications each with 2 bits. UE #1 and UE #2 are configured with the dedicated RNTI and the position for UE #1 and UE #2 is 0 bit and 4 bits respectively.

Assuming that the 1^{st} bit of each indication included in the new group common DCI format indicates a DMRS port mode for DMRS port(s) for PDSCH transmission to a UE, the 2^{nd} bit indicates a DMRS port mode for DMRS port(s) for PUSCH transmission. The bit equals “0” means that the indicated DMRS port(s) is Rel-15 DMRS port(s) and the bit equals “1” means the indicated DMRS port(s) is Rel-18 DMRS port(s).

At a time point t1, the new group common DCI format (e.g., denoted as DCI #0) equals 10000100 and assuming that the application time is 0 symbol after a UE receive DCI #0. UE #1 may determine that the first two bits “10” are the DMRS port mode indication for UE #1. Based on the indication, UE #1 may receive PDSCH transmissions #0, #1, #2 with Rel-18 DMRS ports and transmit PUSCH transmissions #0, #1, #2 with Rel-15 DMRS ports. UE #2 may determine that the 5th and 6th bits, i.e., “01”, are the DMRS port mode indication for UE #2. Based on the indication, UE #2 may receive PDSCH #4 with Rel-15 DMRS ports.

### Embodiment 2-2

In embodiment 2-2, the group common DCI format may indicate DMRS port mode for PDSCH transmission and PUSCH transmission jointly.

In embodiment 2-2, the definitions for the group common DCI format may be the same as those in embodiment 2-1-1 except for that each indication included in the group common DCI format may indicate a DMRS port mode for both a PDSCH transmission and a PUSCH transmission. For example, each indication in embodiment 2-2 may include 1 bit, wherein the bit equals “0” means that the DMRS port mode for DMRS port(s) for both a PDSCH transmission and a PUSCH transmission is Rel-15 DMRS port(s) and the bit equals “1” means that the DMRS port mode for DMRS port(s) for both a PDSCH transmission and a PUSCH transmission is Rel-18 DMRS port(s)

Then, after receiving the group common DCI format scrambled with an RNTI (e.g., DMRS-RNTI) specific or dedicated for DMRS port mode indication, the UE may determine an indication for it based on the same configuration information as those in embodiment 2-1-1. The indication may indicate a DMRS port mode for both a PDSCH transmission and a PUSCH transmission. Then, the UE may apply the DMRS port mode to all the PDSCH transmissions and all the PUSCH transmissions in the active BWP after receiving the indication.

In some embodiments, the UE may apply DMRS port mode to all the PDSCH transmissions and all the PUSCH transmissions in the active BWP after an application time of the group common DCI format. The definitions of the application time in embodiment 2-1-1 may apply here.

In embodiment 2, all the PDSCH transmissions may include at least one of dynamic scheduled PDSCH transmission(s) or SPS PDSCH transmission(s) in the active BWP (e.g., in the active BWP in a serving cell). All the PUSCH transmissions may include at least one of dynamic scheduled PUSCH transmission(s) or CG PUSCH transmission(s) in the active BWP (e.g., in the active BWP in a serving cell).

In some scenarios of the present application, the channel quality between a UE and a BS may not change so fast. The requirements between multiplexing different UEs for high throughput and the performances of the UEs may not switch dynamically. In such scenarios, a MAC-CE may be used to indicate the DMRS port mode for a PDSCH transmission or PUSCH transmission. The following embodiment 3 may illustrate how to use a MAC-CE to indicate a DMRS port mode.

### Embodiment 3

In embodiment 3, a MAC CE may include a field (e.g., denoted as a DMRS port mode field) to indicate a DMRS port mode for at least one of a PDSCH transmission or a PUSCH transmission. In such embodiment, the indication indicating a DMRS port mode may be the DMRS port mode field in the MAC CE.

In some embodiments, the DMRS port mode field may be a new field added to a MAC CE.

In some embodiments, the DMRS port mode field may be a 1-bit field. The first value (e.g., 0) of the 1-bit field may indicate that the DMRS port mode is the first mode and a second value (e.g., 1) of the 1-bit field may indicate that the DMRS port mode is the second mode.

After receiving the MAC CE, the UE may apply the DMRS port mode to all the PDSCH transmissions, or all the PUSCH transmissions, or all the PDSCH transmissions and all the PUSCH transmissions in the active BWP after an application time of the MAC CE. In some embodiments, the application of the MAC CE may be a time period after receiving the MAC CE. For example, the application time may be determined based on the methods as specified in 3GPP standard documents.

In some embodiments, a MAC CE may include a field to indicate a DMRS port mode for DMRS port(s) for a PDSCH transmission. Then, the UE may apply the DMRS port mode to all the PDSCH transmissions in the active BWP after an application time of the MAC CE.

Alternatively or additionally, the MAC CE may also include another field to indicate a DMRS port mode for DMRS port(s) for a PUSCH transmission. Then, the UE may apply the DMRS port mode to all the PUSCH transmissions in the active BWP after an application time of the MAC CE.

In some other embodiments, a MAC CE may include a field to indicate a DMRS port mode for both a PDSCH transmission and a PUSCH transmission. Then, the UE may apply the DMRS port mode to all the PDSCH transmissions and all the PUSCH transmissions in the active BWP after an application time of the MAC CE.

In embodiment 3, all the PDSCH transmissions include at least one of dynamic scheduled PDSCH transmission(s) or SPS PDSCH transmission(s) in the active BWP (e.g., in the active BWP in a serving cell). All the PUSCH transmissions in the active BWP include at least one of dynamic scheduled PUSCH transmission(s) or CG PUSCH transmission(s) in the active BWP (e.g., in the active BWP in a serving cell).

FIG. 5 illustrates an exemplary MAC CE for indicating a DMRS port mode according to some embodiments of the present disclosure.

Referring to FIG. 5, the size of MAC CE is 8*2=16 bits, which may include: reserved fields with 7 bits, which is represented by “R” in FIG. 5, a field with 5 bits indicating a serving cell ID, a field with 2 bits indicating an BWP ID, field #1 with 1 bit indicating a DMRS port mode for PDSCH transmission(s), and field #2 with 1 bit indicating a DMRS port mode for PUSCH transmission(s).

In some scenarios, an RRC signalling may be enough to indicate or update the DMRS port mode of DMRS ports for PDSCH transmission or PUSCH transmission. The following embodiment 4 may illustrate how to indicate a DMRS port mode via an RRC signalling.

### Embodiment 4

In embodiment 4, an RRC signalling may include a field (e.g., denoted as a DMRS port mode field) to indicate a DMRS port mode for a PDSCH transmission or a PUSCH transmission. In such embodiment, the indication indicating a DMRS port mode may be indicated by the RRC signalling, e.g., the indication is the DMRS port mode field in the RRC signalling. In some embodiments, the DMRS port mode field may be a new field added to an RRC signalling.

After receiving the RRC signalling, the UE may apply the DMRS port mode to all the PDSCH transmissions or all the PUSCH transmissions in the active BWP.

In some embodiments, the RRC signalling may be a DL DMRS configuration (e.g., DMRS-DownlinkConfig) or a PDSCH configuration (e.g., PDSCH-Config). After receiving the RRC signalling, the UE may apply the DMRS port mode indicated by the field in the RRC signalling to all the PDSCH transmissions in the active BWP.

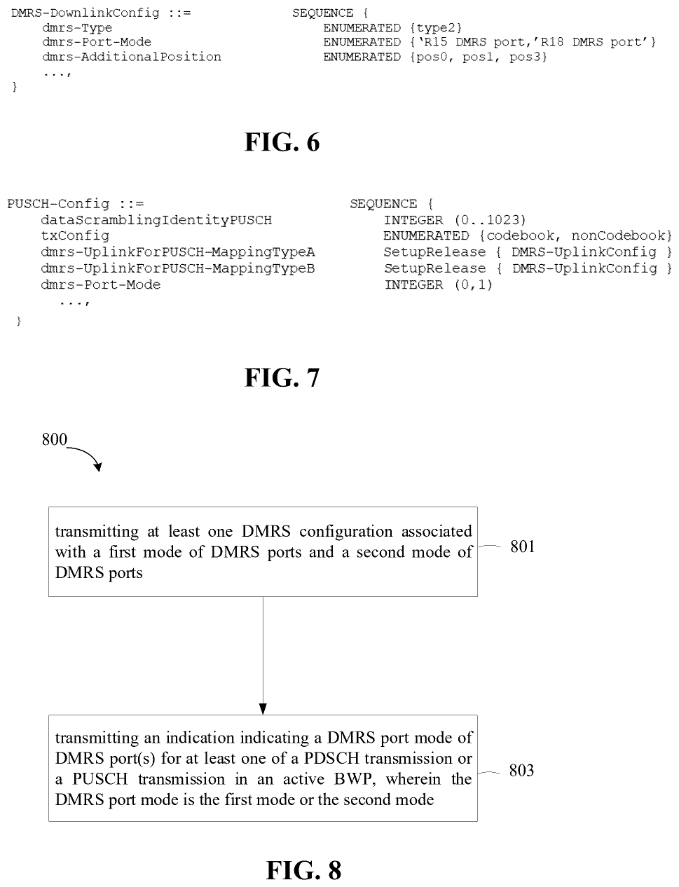

FIG. 6 illustrates an exemplary DL DMRS configuration indicating a DMRS port mode according to some embodiments of the present disclosure.

Referring to FIG. 6, the DL DMRS configuration may be represented by “DMRS-DownlinkConfig.” The DMRS-DownlinkConfig may include a field (e.g., denoted as dmrs-Port-Mode) indicating a DMRS port mode for PDSCH transmission. The value of the field may be “R15 DMRS port” or “R18 DMRS port” directly. In addition to the dmrs-Port-Mode field, other fields may be the same as those included in DMRS-DownlinkConfig as specified in TS 38.331.

In some embodiments, the RRC signalling may be a UL DMRS configuration (e.g., DMRS-UplinkConfig) or a PUSCH configuration (e.g., PUSCH-Config or ConfiguredGrantConfig). After receiving the RRC signalling, the UE may apply the DMRS port mode indicated by the field in the RRC signalling to all the PUSCH transmissions in the active BWP.

FIG. 7 illustrates an exemplary PUSCH configuration indicating a DMRS port mode according to some embodiments of the present disclosure;

Referring to FIG. 7, the PUSCH configuration may be represented by “PUSCH-Config.” The PUSCH-Config may include a field (e.g., denoted as dmrs-Port-Mode) indicating a DMRS port mode for PUSCH transmission. The value of the field may be “0” or “1,” where “0” means the indicated DMRS port(s) for the PUSCH transmissions is Rel-15 DMRS port(s) and “1” means the indicated DMRS port(s) for the PUSCH transmissions is Rel-18 DMRS port(s). In addition to the dmrs-Port-Mode field, other fields may be the same as those included in PUSCH-Config as specified in TS 38.331.

In some embodiments, for a type 1 CG PUSCH transmission, the RRC signalling may be a CG configuration. After receiving the RRC signalling, the UE may apply the DMRS port mode indicated by the field in the RRC signalling to all the CG PUSCH transmission which is based on the CG configuration.

In embodiment 4, all the PDSCH transmissions include at least one of dynamic scheduled PDSCH transmission(s) or SPS PDSCH transmission(s) in the active BWP (e.g., in the active BWP in a serving cell). All the PUSCH transmissions include at least one of dynamic scheduled PUSCH transmission(s) or CG PUSCH transmission(s) in the active BWP (e.g., in the active BWP in a serving cell).

FIG. 8 is a flow chart illustrating an exemplary method 800 for determining DMRS ports according to some other embodiments of the present disclosure. The method in FIG. 8 may be implemented by a BS (e.g., BS 102 as shown in FIG. 1).

In the exemplary method shown in FIG. 8, in step 801, the BS may transmit at least one DMRS configuration associated with a first mode of DMRS ports and a second mode of DMRS ports to a UE (e.g., UE 101a or UE 101b as shown in FIG. 1). All the definitions regarding first mode of DMRS ports, second mode of DMRS ports, and the at least one DMRS configuration in FIG. 2 may apply here.

In step 803, the BS may transmit an indication indicating a DMRS port mode of DMRS port(s) for at least one of a PDSCH transmission or a PUSCH transmission in an active BWP to the UE. The DMRS port mode may be the first mode or the second mode.

In some embodiments of the present application, the BS may determine DMRS port(s) for PDSCH transmission(s) or PUSCH transmission(s) based on the DMRS port mode and the at least one DMRS configuration. The specific operation will be described in detail below.

### Embodiment 1′

In embodiment 1′, the DMRS port mode of DMRS port(s) may be indicated by a UE specific DCI format or a CG configuration. Based on the different indicating methods, embodiment 1′ may further include embodiment 1′-1, embodiment 1′-2, and embodiment 1′-3.

### Embodiment 1′-1

In embodiments 1′-1, the DMRS port mode may be explicitly indicated by a field (e.g., denoted as a DMRS port mode field) in a non-fallback DCI format for scheduling or activating a PDSCH transmission or a PUSCH transmission or in a CG configuration. In such embodiment, the indication indicating a DMRS port mode may be the DMRS port mode field in a non-fallback DCI format or in a CG configuration. The definitions regarding the non-fallback DCI format and the DMRS port mode field in embodiment 1-1 may apply here.

In an embodiment, whether the DMRS port mode field is included in a non-fallback DCI format may be configured by an RRC signalling. For example, if a UE supports both the first mode of DMRS ports and the second mode of DMRS ports and support dynamic switching between the first mode of DMRS port and the second mode of DMRS port, the BS may transmit an RRC signalling indicating that the DMRS port mode field is included in a non-fallback DCI format to the UE.

In some cases, the non-fallback DCI format may be a non-fallback DCI format for scheduling a PDSCH transmission (or a PUSCH transmission) or a PDSCH retransmission (or a PUSCH retransmission). In some other cases, for a type 2 CG PUSCH transmission (or a SPS PDSCH transmission), the non-fallback DCI format may be a non-fallback DCI format for activating the type 2 CG PUSCH transmission (or activating the SPS PDSCH transmission). In some cases of embodiment 1′-1, for a type 1 CG PUSCH transmission, the field is included in a CG configuration to indicate the DMRS port mode for the type 1 CG PUSCH transmission.

In the above cases, for a PDSCH transmission or a PUSCH transmission, the BS may determine an antenna port table based on the DMRS port mode indicated by the DMRS port mode field and a DMRS configuration of the at least one DMRS configuration for the PDSCH transmission (or the PUSCH transmission), wherein the DMRS configuration may be associated with the DMRS port mode indicated by the DMRS port mode field. Then, the BS may determine DMRS port(s) for the PDSCH transmission (or the PUSCH transmission) based on the antenna port table and an antenna port field included in the non-fallback DCI format.

In an embodiment of the present application, the first mode of DMRS ports and the second mode of DMRS ports may be associated with different antenna port tables. In such embodiments, the methods and definitions for the different antenna port tables in embodiment 1-1 may apply here.

In another embodiment of the present application, the first mode of DMRS ports and the second mode of DMRS ports may share the same antenna port table(s). In such embodiments, the methods and definitions for the same antenna port tables in in embodiment 1-1 may apply here.

In the above embodiments, a bit width of the antenna port field included in the non-fallback DCI format may be a maximum bit width of a bit width required to indicate antenna port(s) (i.e., DMRS port(s)) for the first mode of DMRS ports and a bit width required to indicate antenna port(s) (i.e., DMRS port(s)) for the second mode of DMRS ports.

In some cases of embodiment 1′-1, for a PDSCH transmission (or a PUSCH transmission) scheduled by a fallback DCI format, the DMRS port mode is the first mode for the PDSCH transmission (or the PUSCH transmission). In such embodiments, the fallback DCI format does not include a field indicating a DMRS port mode. For the fallback DCI format scheduling a PDSCH transmission (or a PUSCH transmission), the BS may determine that a DMRS port mode for DMRS port(s) for the PDSCH transmission (or a PUSCH transmission) is the first mode (i.e., Rel-15 DMRS ports).

### Embodiment 1′-2

In embodiment 1′-2, the first mode of DMRS ports and the second mode of DMRS ports may share the same antenna port tables. The DMRS port mode of DMRS port(s) may be implicitly in a non-fallback DCI format for a PDSCH transmission or a PUSCH transmission or in a CG configuration. For example, the DMRS port mode may be indicated by an antenna port field included in a non-fallback DCI format or in a CG configuration. In such embodiments, the indication indicating a DMRS port mode may be an antenna port field included in a non-fallback DCI format or in a CG configuration. The definitions regarding the non-fallback DCI format in embodiment 1-2 may apply here.

In some cases, the non-fallback DCI format may be a non-fallback DCI format for scheduling a PDSCH transmission (or a PUSCH transmission) or a PDSCH retransmission (or a PUSCH retransmission). In some other cases, for a type 2 CG PUSCH transmission (or a SPS PDSCH transmission), the non-fallback DCI format may be a non-fallback DCI format a non-fallback DCI format for activating the type 2 CG PUSCH transmission (or a SPS PDSCH transmission). In some cases of embodiment 1′-2, for a type 1 CG PUSCH transmission, the field is included in a CG configuration to indicate the DMRS port mode for the type 1 CG PUSCH transmission.

In the above cases, for a PDSCH transmission or a PUSCH transmission, the BS may determine the DMRS port mode for the PDSCH transmission or the PUSCH transmission based on the antenna port field. The following embodiments provide several methods for determining the DMRS port mode based on the antenna port field.

In an embodiment, based on the DMRS configurations for the first mode of DMRS ports and the second mode of DMRS ports, the BS may determine an antenna port table shared by the first mode of DMRS ports and the second mode of DMRS ports. The antenna port table may include first set of entries associated with the first mode of DMRS ports and a second set of entries associated with the second mode of DMRS ports. The antenna port field may indicate an index of an entry in the antenna port table, wherein the entry may indicate the DMRS port(s) and the DMRS port mode. Then, the BS may determine the DMRS port mode of the DMRS port(s) based on the entry index of the entry indicated by the antenna port field. For example, in the case that the entry index indicates that the entry belongs to the first set of entries, the BS may determine that the DMRS port mode of the DMRS ports in the entry is the first mode; in the case that the entry index indicates that the entry belongs to the second set of entries, the BS may determine that the DMRS port mode of the DMRS ports in the entry is the second mode.

In another embodiment, the FDM method or comb method may be adopted to increase the number of DMRS ports. Then, the DMRS port mode may be implicitly indicated by the column “Number of DMRS CDM group(s) without data” in a DMRS port table (i.e., antenna port table) since more CDM groups may be introduced for increasing the number of DMRS ports.

For example, based on the DMRS configuration for the first mode of DMRS ports and the second mode of DMRS ports, the BS may determine an antenna port table shared by the first mode of DMRS ports and the second mode of DMRS ports. The antenna port field may indicate an index of an entry in the antenna port table. Then, the BS may determine the DMRS port mode of the DMRS port(s) in the entry based on the number of DMRS CDM groups without data indicated by the entry.

For example, in the case that the number of DMRS CDM groups without data is not larger than 2 for DMRS type 1 or not larger than 3 for DMRS type 2, the BS may determine that the DMRS port mode of the DMRS port(s) is the first mode; in the case that the number of DMRS CDM groups without data is larger than 2 for DMRS type 1 or larger than 3 for DMRS type 2, the BS may determine that the DMRS port mode of the DMRS port(s) is the second mode.

In another embodiment, the FD-OCC with length 4 or length 6 may be adopted to increase the number of DMRS ports.

In some cases, one column may be added in an antenna port table to indicate the length of FD-OCC. Then, the BS may determine the DMRS port mode based on the length of FD-OCC.

For example, based on the DMRS configurations for the first mode of DMRS ports and the second mode of DMRS ports, the BS may determine an antenna port table shared by the first mode of DMRS ports and the second mode of DMRS ports. The antenna port field may indicate an index of an entry in the antenna port table. Then, the BS may determine the DMRS port mode of the DMRS port(s) in the entry based on a length of FD-OCC indicated by the entry.

For example, in the case that the length of FD-OCC is 2, the BS may determine that the DMRS port mode of the DMRS port(s) in the entry is the first mode; in the case that the number of DMRS CDM group is larger than 2 (e.g., 4 or 6 if FD-OCC with length 4 or 6 is adopted in Rel-18 to increase the number of DMRS ports), the BS may determine that the DMRS port mode of the DMRS port(s) in the entry is the second mode.

In some other cases, one column may be added in an antenna port table to indicate the number of DMRS ports within a CDM group. Then, the BS may determine the DMRS port mode based on the number of DMRS ports within a CDM group.

For example, based on the DMRS configurations for the first mode of DMRS ports and the second mode of DMRS ports, the BS may determine an antenna port table shared by the first mode of DMRS ports and the second mode of DMRS ports. The antenna port field may indicate an index of an entry in the antenna port table. Then, the BS may determine the DMRS port mode of the DMRS port(s) in the entry based on the number of DMRS ports within a CDM group indicated by the entry.

For example, in the case that the number of DMRS ports within a CDM group is 2 for single-symbol DMRS or 4 for double-symbol DMRS, the BS may determine that the DMRS port mode of the DMRS port(s) is the first mode; in the case that the number of DMRS ports within a CDM group is 4 for single-symbol DMRS or is 8 for double-symbol DMRS, the BS may determine that the DMRS port mode of the DMRS port(s) is the second mode.

In some cases of embodiment 1′-2, for a PDSCH transmission (or a PUSCH transmission) scheduled by a fallback DCI format, the DMRS port mode is the first mode for the PDSCH transmission (or the PUSCH transmission). For a PDSCH transmission, a fallback DCI format may be DCI format 1_0 as specified in 3GPP standard documents. For a PUSCH transmission, a fallback DCI format may be DCI format 0_0 as specified in 3GPP standard documents.

In such cases, the fallback DCI format does not include a field indicating a DMRS port mode. For the fallback DCI format scheduling a PDSCH transmission (or a PUSCH transmission), the BS may determine that a DMRS port mode for DMRS port(s) for the PDSCH transmission (or a PUSCH transmission) is the first mode (i.e., Rel-15 DMRS ports).

### Embodiment 1′-3

In embodiment 1′-3, a DMRS port mode may apply to a plurality of PDSCH transmission or PUSCH transmissions. In such embodiments, the indication indicating a DMRS port mode may be a field (e.g., denoted as a DMRS port mode field) in a non-fallback DCI format for scheduling a PDSCH transmission or a PUSCH transmission. The definitions regarding the non-fallback DCI format and the DMRS port mode field in embodiment 1-3 may apply here.

After transmitting the indication indicating a DMRS port mode, the BS may apply to DMRS port mode to all the PDSCH transmissions or all the PUSCH transmissions in the active BWP (e.g., in the active BWP in a serving cell) after an application time of the indication, which means that the BS may determine that the DMRS port(s) of all PDSCH transmission or all PUSCH transmission is the first mode of DMRS ports or the second mode of DMRS ports by the same DMRS port mode. The application time may be determined based on the following methods. The definitions of the application time in embodiment 1-3 may apply here.

For example, for the non-fallback DCI format scheduling the PDSCH transmission, the application time is a number of time units after the last symbol of a PUCCH carrying HARQ-ACK information (e.g., ACK or NACK) for the PDSCH transmission. For the non-fallback DCI format scheduling the PUSCH transmission, the application time is a number of time units after the last symbol of another DCI format scheduling another PUSCH transmission with a same HARQ process number and having a toggled NDI field value.

All the methods for applying the DMRS port mode to all the PDSCH transmissions or all the PUSCH transmissions and determining the DMRS port(s) based on the DMRS port mode in embodiment 1-3 may apply here.

### Embodiment 2′

In embodiment 2′, the DMRS port mode of DMRS port(s) may be indicated by a group common DCI format. Based on the different indicating methods, embodiment 2 may further include embodiment 2′-1 and embodiment 2′-2.

### Embodiment 2′-1

In embodiment 2′-1, the group common DCI may indicate DMRS port mode for PDSCH transmission and PUSCH transmission separately.

### Embodiment 2′-1-1

In embodiment 2′-1-1, the BS may transmit a group common DCI format scrambled with an RNTI (e.g., DMRS-RNTI) specific or dedicated for DMRS port mode indication to the UE.

The group common DCI format may include one or more indications, wherein each indication of the one or more indications is for a corresponding UE. Each indication may include an indication indicating a DMRS port mode for PDSCH transmission for a corresponding UE and another indication indicating a DMRS port mode for PUSCH transmission for the corresponding UE. In such embodiment, all the definitions regarding group common DCI format in embodiment 2-1-1 may apply here.

Before transmitting the group common DCI format, the BS may transmit configuration information indicating the RNTI specific or dedicated for DMRS port mode indication to a UE. The BS may also transmit configuration information indicating a payload size of a group common DCI format and a start position (e.g., the start bit) of an indication for the UE within the group common DCI format.

The BS may determine an indication for the UE based on the above configuration information, the indication may include a first indication indicating a DMRS port mode (e.g., denoted as DMRS port mode #1) for DMRS port(s) for a PDSCH transmission and a second indication indicating a DMRS port mode (e.g., denoted as DMRS port mode #2) DMRS port(s) for a PUSCH transmission. The BS may apply DMRS port mode #1 to all the PDSCH transmissions in the active BWP after transmitting the first indication. Alternatively or additionally, the BS may apply DMRS port mode #2 to all the PUSCH transmissions in the active BWP after transmitting the second indication.

In some cases, the BS may apply DMRS port mode #1 to all the PDSCH transmissions or apply DMRS port mode #2 to all the PUSCH transmissions in the active BWP after an application time of the group common DCI format. The application time is a number of time units after the UE receives the group common DCI format. A time unit may be a slot, a symbol, a sub-slot, 1 ms, etc.

In some cases, the number of time units may be configured by a higher layer (e.g., a layer higher than a physical layer) signalling. In some embodiments, the number of time units may be not configured for the UE, the BS may use a default value (e.g., 0) as the number of time units. In such embodiments, the BS may apply to DMRS port mode to all the PDSCH transmissions or all the PUSCH transmissions in the active BWP (e.g., in the active BWP in a serving cell) in response to (e.g., after or upon) transmitting the group common DCI format.

### Embodiment 2′-1-2

In embodiment 2′-1-2, to indicate the DMRS port mode for DMRS port(s) for PDSCH and DMRS port(s) for PUSCH transmissions separately, the group common DCI can be scrambled by different dedicated RNTIs (DL-DMRS-RNTI and UL-DMRS-RNTI) for PDSCH transmission and PUSCH transmission, respectively.

In such embodiment, the BS may transmit a group common DCI format scrambled with a DL-RNTI specific for DMRS port mode indication for a PDSCH transmission or a UL-RNTI specific for DMRS port mode indication for a PUSCH transmission.

In such embodiment, the group common DCI format may also include one or more indications as in embodiment 2′-1-1. The difference is that each indication may indicate a DMRS port mode for PDSCH transmission in the case that the group common DCI format scrambled with the DL-RNTI or indicate a DMRS port mode for PUSCH transmission in the case that the group common DCI format scrambled with the UL-RNTI.

Before transmitting the group common DCI format, the BS may also transmit, to a UE, configuration information indicating a DL-RNTI dedicated for DMRS port mode indication for PDSCH transmission and a UL-RNTI dedicated for DMRS port mode indication for PUSCH transmission and configuration information indicating a payload size of a group common DCI format and a start position (e.g., the start bit) of an indication for the UE within the group common DCI format.

The BS may determine an indication for a UE based on the above configuration information. In the case that the group common DCI format is scrambled with the DL-RNTI specific for DMRS port mode indication for a PDSCH transmission, the BS apply the DMRS port mode indicated by the indication to all the PDSCH transmissions in the active BWP after receiving the indication; in the case that group common DCI format is scrambled with the UL-RNTI specific for DMRS port mode indication for a PUSCH transmission, the UE apply the DMRS port mode indicated by the indication to all the PUSCH transmissions in the active BWP after receiving the indication.

In some cases, the BS may apply DMRS port mode to all the PDSCH transmissions or all the PUSCH transmissions in the active BWP after an application time of the group common DCI format. The definitions of the application time in embodiment 2′-1-1 may apply here.

### Embodiment 2′-2

In embodiment 2′-2, the group common DCI format may indicate DMRS port mode for PDSCH transmission and PUSCH transmission jointly.

In such embodiment, the BS may transmit group common DCI format scrambled with an RNTI (e.g., DMRS-RNTI) specific or dedicated for DMRS port mode indication to a UE. The definitions for the group common DCI format in embodiment 2-2 may apply here.

Before transmitting the specific or dedicated for DMRS port mode indication, the BS may also transmit, to the UE, configuration information indicating the RNTI specific or dedicated for DMRS port mode indication and configuration information indicating a payload size of a group common DCI format and a start position (e.g., the start bit) of an indication for the UE within the group common DCI format.

The BS may determine an indication in the group common DCI format for a UE based on the above configuration information. The indication may indicate a DMRS port mode for both a PDSCH transmission and a PUSCH transmission. The BS may apply the DMRS port mode to all the PDSCH transmissions and all the PUSCH transmissions in the active BWP after transmitting the indication.

In some cases, the BS may apply DMRS port mode to all the PDSCH transmissions and all the PUSCH transmissions in the active BWP after an application time of the group common DCI format. The definitions of the application time in embodiment 2′-1-1 may apply here.

In the above embodiments, all the PDSCH transmissions may include at least one of dynamic scheduled PDSCH transmission(s) or SPS PDSCH transmission(s) in the active BWP (e.g., in the active BWP in a serving cell). All the PUSCH transmissions in the active BWP may include at least one of dynamic scheduled PUSCH transmission(s) or CG PUSCH transmission(s) in the active BWP (e.g., in the active BWP in a serving cell).

### Embodiment 3′

In embodiment 3′, a MAC CE may include a field (e.g., denoted as a DMRS port mode field) to indicate a DMRS port mode for at least one of a PDSCH transmission or a PUSCH transmission. In such embodiment, the indication indicating a DMRS port mode may be the DMRS port mode field in the MAC CE. The definitions of the DMRS port mode field in embodiment 3 may apply here.

After transmitting the MAC CE, the BS may apply the DMRS port mode to all the PDSCH transmissions, or all the PUSCH transmissions, or all the PDSCH transmissions and all the PUSCH transmissions in the active BWP after an application time of the MAC CE. In some embodiments, the application of the MAC CE may be a time period after transmitting the MAC CE. For example, the application time may be determined based on the methods as specified in 3GPP standard documents.

In some embodiments, a MAC CE may include a field to indicate a DMRS port mode for DMRS port(s) for a PDSCH transmission. Then, the BS may apply the DMRS port mode to all the PDSCH transmissions in the active BWP after an application time of the MAC CE.

Alternatively or additionally, the MAC CE may also include another field to indicate a DMRS port mode for DMRS port(s) for a PUSCH transmission. Then, the BS may apply the DMRS port mode to all the PUSCH transmissions in the active BWP after an application time of the MAC CE.

In some other embodiments, a MAC CE may include a field to indicate a DMRS port mode for both a PDSCH transmission and a PUSCH transmission. Then, the BS may apply the DMRS port mode to all the PDSCH transmissions and all the PUSCH transmissions in the active BWP after an application time of the MAC CE.

In the above embodiments, all the PDSCH transmissions include at least one of dynamic scheduled PDSCH transmission(s) or SPS PDSCH transmission(s) in the active BWP (e.g., in the active BWP in a serving cell). All the PUSCH transmissions include at least one of dynamic scheduled PUSCH transmission(s) or CG PUSCH transmission(s) in the active BWP (e.g., in the active BWP in a serving cell).

### Embodiment 4′

In embodiment 4′, an RRC signalling may include a field (e.g., denoted as a DMRS port mode field) to indicate a DMRS port mode for a PDSCH transmission or a PUSCH transmission. In such embodiment, the indication indicating a DMRS port mode may be indicated by the RRC signalling, e.g., the indication is the DMRS port mode field in the RRC signalling. In some embodiments, the DMRS port mode field may be a new field added to an RRC signalling.

The BS may apply the DMRS port mode to all the PDSCH transmissions or all the PUSCH transmissions in the active BWP.

In some embodiments, the RRC signalling may be a DL DMRS configuration (e.g., DMRS-DownlinkConfig) or a PDSCH configuration (e.g., PDSCH-Config). The BS may apply the DMRS port mode indicated by the field in the RRC signalling to all the PDSCH transmissions in the active BWP.

In some embodiments, the RRC signalling may be a UL DMRS configuration (e.g., DMRS-UplinkConfig) or a PUSCH configuration (e.g., PUSCH-Config). The BS may apply the DMRS port mode indicated by the field in the RRC signalling to all the PUSCH transmissions in the active BWP.

In some embodiments, for a type 1 CG PUSCH transmission, the RRC signalling may be a CG configuration. The BS may apply the DMRS port mode indicated by the field in the RRC signalling to all the CG PUSCH transmission which is based on the CG configuration.

In the above embodiments, all the PDSCH transmissions include at least one of dynamic scheduled PDSCH transmission(s) or SPS PDSCH transmission(s) in the active BWP (e.g., in the active BWP in a serving cell). All the PUSCH transmissions include at least one of dynamic scheduled PUSCH transmission(s) or CG PUSCH transmission(s) in the active BWP (e.g., in the active BWP in a serving cell).

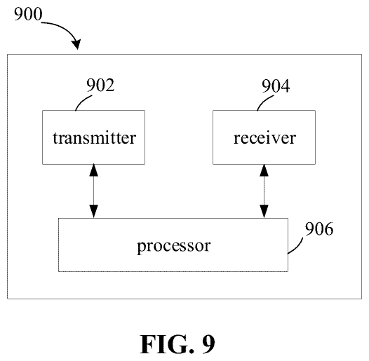

FIG. 9 illustrates a simplified block diagram of an exemplary apparatus 900 for determining DMRS port mode according to some embodiments of the present disclosure. In some embodiments, the apparatus 900 may be or include at least part of a UE (e.g., UE 101a or UE 101b in FIG. 1). In some other embodiments, the apparatus 900 may be or include at least part of a BS (e.g., BS 102 in FIG. 1).

Referring to FIG. 9, the apparatus 900 may include at least one transmitter 902, at least one receiver 904, and at least one processor 906. The at least one transmitter 902 is coupled to the at least one processor 906, and the at least one receiver 904 is coupled to the at least one processor 906.

Although in this figure, elements such as the transmitter 902, the receiver 904, and the processor 906 are illustrated in the singular, the plural is contemplated unless a limitation to the singular is explicitly stated. In some embodiments of the present disclosure, the transmitter 902 and the receiver 904 may be combined to one device, such as a transceiver. In some embodiments of the present disclosure, the apparatus 900 may further include an input device, a memory, and/or other components. The transmitter 902, the receiver 904, and the processor 906 may be configured to perform any of the methods described herein (e.g., the method described with respect to FIGS. 2-8).

According to some embodiments of the present disclosure, the apparatus 900 may be a UE, and the transmitter 902, the receiver 904, and the processor 906 may be configured to perform operations of the method as described with respect to FIG. 2. For example, the receiver 904 may be configured to receive at least one DMRS configuration associated with a first mode of DMRS ports and a second mode of DMRS ports; and receive an indication indicating a DMRS port mode of DMRS port(s) for at least one of a PDSCH or a PUSCH transmission in an active BWP, wherein the DMRS port mode is the first mode or the second mode.

According to some embodiments of the present disclosure, the apparatus 900 may be a BS, and the transmitter 902, the receiver 904, and the processor 906 may be configured to perform operations of the method as described with respect to FIG. 8. For example, the transmitter 902 may be configured to transmit at least one DMRS configuration associated with a first mode of DMRS ports and a second mode of DMRS ports; and transmit an indication indicating a DMRS port mode of DMRS port(s) for at least one of a PDSCH or a PUSCH transmission in an active BWP, wherein the DMRS port mode is the first mode or the second mode.

In some embodiments of the present disclosure, the apparatus 900 may further include at least one non-transitory computer-readable medium. In some embodiments of the present disclosure, the non-transitory computer-readable medium may have stored thereon computer-executable instructions to cause the processor 906 to implement any of the methods as described above. For example, the computer-executable instructions, when executed, may cause the processor 906 to interact with the transmitter 902 and/or the receiver 904, so as to perform operations of the methods, e.g., as described with respect to FIGS. 2-8.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present disclosure provides an apparatus of determining DMRS port mode, including a processor and a memory. Computer programmable instructions for implementing a method of determining DMRS port mode are stored in the memory, and the processor is configured to perform the computer programmable instructions to implement the method of determining DMRS port mode. The method of determining DMRS port mode may be any method as described in the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method of determining DMRS port mode according to any embodiment of the present disclosure.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
receive at least one demodulation reference signal (DMRS) configuration associated with a first mode of DMRS ports and a second mode of DMRS ports; and
receive an indication indicating a DMRS port mode of the DMRS ports for at least one of a physical downlink shared channel (PDSCH) transmission or a physical uplink shared channel (PUSCH) transmission in an active bandwidth part (BWP), wherein the DMRS port mode is the first mode or the second mode of the DMRS ports.

2. The UE of claim 1, wherein the indication is a DMRS port mode field in a non-fallback downlink control information (DCI) format for scheduling or activating the PDSCH transmission or the PUSCH transmission, and wherein the at least one processor is further configured to cause the UE to:
determine an antenna port table based on the DMRS port mode and a DMRS configuration of the at least one DMRS configuration for the PDSCH transmission or the PUSCH transmission, wherein the DMRS configuration is associated with the DMRS port mode of the DMRS ports indicated by the indication; and
determine DMRS ports for the PDSCH transmission or the PUSCH transmission based on the antenna port table and an antenna port field included in the non-fallback DCI format.

3. The UE of claim 2, wherein a bit width of the antenna port field included in the non-fallback DCI format is a maximum bit width of a bit width required to indicate antenna ports for the first mode of DMRS ports and a bit width required to indicate antenna ports for the second mode of DMRS port.

4. The UE of claim 1, wherein the indication is a DMRS port mode field in a configured grant (CG) configuration for the PUSCH transmission when the PUSCH transmission is a type 1 CG PUSCH transmission.

5. The UE of claim 1, wherein the indication is an antenna port field in a non-fallback DCI format for scheduling or activating the PDSCH transmission or the PUSCH transmission, and the antenna port field indicates an index of an entry, which indicates the DMRS ports and the DMRS port mode, of an antenna port table shared by the first mode of the DMRS ports and the second mode of the DMRS ports.

6. The UE of claim 5, wherein the at least one processor is further configured to cause the UE to:
determine the DMRS port mode of the DMRS ports based on the number of DMRS code division multiplexing (CDM) groups without data indicated by the entry;
determine the DMRS port mode of the DMRS ports based on a length of frequency-domain orthogonal cover code (FD-OCC) indicated by the entry; or
determine the DMRS port mode of the DMRS ports based on the number of DMRS ports within a CDM group indicated by the entry.

7. The UE of claim 1, wherein the DMRS port mode is the first mode for the PDSCH transmission or the PUSCH transmission scheduled by a fallback DCI format.

8. The UE of claim 1, wherein the indication is a DMRS port mode field in a non-fallback DCI format scheduling or activating the PDSCH transmission or the PUSCH transmission, and wherein the at least one processor is further configured to cause the UE to:
apply the DMRS port mode to all the PDSCH transmissions or all the PUSCH transmissions in the active BWP after an application time of the indication.

9. The UE of claim 1, wherein the indication is indicated by a group common downlink control information (DCI) format scrambled with a radio network temporary identity (RNTI) specific for DMRS port mode indication.

10. The UE of claim 9, wherein the group common DCI format includes one or more indications, wherein each indication of the one or more indications is for a corresponding UE, and wherein the at least one processor is further configured to cause the UE to receive configuration information indicating the RNTI and configuration information indicating a payload size of the group common DCI format and a start position of the indication for the UE within the group common DCI format.

11. The UE of claim 10, wherein the indication includes a first indication indicating a DMRS port mode for a PDSCH transmission and a second indication indicating a DMRS port mode for a PUSCH transmission, and wherein the at least one processor is further configured to cause the UE to:
apply the DMRS port mode for a PDSCH transmission to all the PDSCH transmissions in the active BWP after receiving the first indication; and
apply the DMRS port mode for a PUSCH transmission to all the PUSCH transmissions in the active BWP after receiving the second indication.

12. The UE of claim 1, wherein the indication is a DMRS port mode field in a medium access control (MAC) control element (CE), and wherein the at least one processor is further configured to cause the UE to:
apply the DMRS port mode to all the PDSCH transmissions, all the PUSCH transmission, or all the PDSCH transmissions and all the PUSCH transmission in the active BWP after an application time of the MAC CE.

13. The UE of claim 12,
wherein all the PDSCH transmissions include at least one of dynamic scheduled PDSCH transmissions or semi-persistent scheduling (SPS) PDSCH transmissions in the active BWP; or
wherein all the PUSCH transmissions includes at least one of dynamic scheduled PUSCH transmissions or CG PUSCH transmissions in the active BWP.

14. A base station (BS) for wireless communication, comprising:
at least one memory; and
at least one processor coupled with the at least one memory and configured to cause the BS to:
transmit at least one demodulation reference signal (DMRS) configuration associated with a first mode of DMRS ports and a second mode of the DMRS ports; and
transmit an indication indicating a DMRS port mode of the DMRS ports for at least one of a physical downlink shared channel (PDSCH) transmission or a physical uplink shared channel (PUSCH) transmission in an active bandwidth part (BWP), wherein the DMRS port mode is the first mode or the second mode.

15. A method performed by a user equipment (UE), the method comprising:
receiving at least one demodulation reference signal (DMRS) configuration associated with a first mode of DMRS ports and a second mode of the DMRS ports; and
receiving an indication indicating a DMRS port mode of the DMRS ports for at least one of a physical downlink shared channel (PDSCH) transmission or a physical uplink shared channel (PUSCH) transmission in an active bandwidth part (BWP), wherein the DMRS port mode is the first mode or the second mode.

16. A processor for wireless communication, comprising:
at least one controller coupled with at least one memory and configured to cause the processor to:
receive at least one demodulation reference signal (DMRS) configuration associated with a first mode of DMRS ports and a second mode of DMRS ports; and
receive an indication indicating a DMRS port mode of the DMRS ports for at least one of a physical downlink shared channel (PDSCH) transmission or a physical uplink shared channel (PUSCH) transmission in an active bandwidth part (BWP), wherein the DMRS port mode is the first mode or the second mode of the DMRS ports.

17. The processor of claim 16, wherein the indication is a DMRS port mode field in a non-fallback downlink control information (DCI) format for scheduling or activating the PDSCH transmission or the PUSCH transmission, and wherein the at least one controller is further configured to cause the processor to:
determine an antenna port table based on the DMRS port mode and a DMRS configuration of the at least one DMRS configuration for the PDSCH transmission or the PUSCH transmission, wherein the DMRS configuration is associated with the DMRS port mode of the DMRS ports indicated by the indication; and
determine DMRS ports for the PDSCH transmission or the PUSCH transmission based on the antenna port table and an antenna port field included in the non-fallback DCI format.

18. The processor of claim 17, wherein a bit width of the antenna port field included in the non-fallback DCI format is a maximum bit width of a bit width required to indicate antenna ports for the first mode of DMRS ports and a bit width required to indicate antenna ports for the second mode of DMRS port.

19. The processor of claim 16, wherein the indication is a DMRS port mode field in a configured grant (CG) configuration for the PUSCH transmission when the PUSCH transmission is a type 1 CG PUSCH transmission.

20. The processor of claim 16, wherein the indication is an antenna port field in a non-fallback DCI format for scheduling or activating the PDSCH transmission or the PUSCH transmission, and the antenna port field indicates an index of an entry, which indicates the DMRS ports and the DMRS port mode, of an antenna port table shared by the first mode of the DMRS ports and the second mode of the DMRS ports.
